(19) United States
(12) Patent Application Publication
(10) Pub. No.: US 2024/0177902 A1
(43) Pub. Date: May 30, 2024

(54) MAGNETIC CORE AND MAGNETIC COMPONENT

(71) Applicant: TDK CORPORATION, Tokyo (JP)

(72) Inventors: Kazuhiro YOSHIDOME, Tokyo (JP); Kensuke ARA, Tokyo (JP)

(73) Assignee: TDK CORPORATION, Tokyo (JP)

(21) Appl. No.: 18/358,191

(22) Filed: Jul. 25, 2023

(30) Foreign Application Priority Data
Nov. 30, 2022 (JP) 2022-192082

(51) Int. Cl. H01F 1/20; B22F 1/052; B22F 1/08; B22F 1/103; B22F 1/142; B22F 1/16; B22F 3/02; B22F 3/24; B22F 9/08

(52) U.S. Cl. CPC H01F 1/20; B22F 1/052; B22F 1/08; B22F 1/103; B22F 1/142; B22F 1/16; B22F 3/02; B22F 3/24; B22F 9/082; B22F 2003/248; B22F 2009/0824; B22F 2301/35; B22F 2304/10; B22F 2998/10

(57) ABSTRACT

Provided is a magnetic core containing metal magnetic particles. A total area ratio occupied by the metal magnetic particles on a cross-section of the magnetic core is 75% or more. The metal magnetic particles include first large particles having an amorphous structure and having a Heywood diameter of 3 μm or more on the cross-section of the magnetic core, and second large particles having a nanocrystal structure and having a Heywood diameter of 3 μm or more on the cross-section of the magnetic core. An insulation coating of the first large particles is thicker than an insulation coating of the second large particles.

### BACKGROUND OF THE INVENTION

### 1. Field of the Invention

The present invention relates to a magnetic core containing a metal magnetic powder and a magnetic component.

### 2. Description of the Related Art

A magnetic core (dust core) containing a metal magnetic powder and a resin is used, for example, in magnetic components such as an inductor, a transformer, and a choke coil. Various attempts have been made on the magnetic core to improve various characteristics such as magnetic permeability.

For example, in JP 2004-197218 A and JP 2004-363466 A, attempts have been made to improve a packing rate of metal magnetic powder in a magnetic core and to improve magnetic permeability and a core loss (magnetic loss) by using a metal magnetic powder obtained by mixing a crystalline alloy powder and an amorphous alloy powder.

In addition, in JP 2011-192729 A, attempts have been made to improve the packing rate of the metal magnetic powder and to improve the magnetic permeability by using two kinds of metal magnetic powders different in a particle size and by adjusting a particle size ratio of the two kinds of metal magnetic powders within a predetermined range.

### CITATION LIST

### Patent Document

Patent Document 1: JP 2004-197218 A
Patent Document 2: JP 2004-363466 A
Patent Document 3: JP 2011-192729 A

### SUMMARY OF THE INVENTION

The present invention has been made in consideration of such circumstances, and an object thereof is to provide a magnetic core and a magnetic component capable of improving a core loss by an approach different from the related art.

To accomplish the object, a magnetic core according to an aspect of the present invention is a magnetic core containing metal magnetic particles. A total area ratio occupied by the metal magnetic particles on a cross-section of the magnetic core is 75% or more. The metal magnetic particles include, first large particles having an amorphous structure and having a Heywood diameter of 3 μm or more on the cross-section of the magnetic core, and second large particles having a nanocrystal structure and having a Heywood diameter of 3 μm or more on the cross-section of the magnetic core. An insulation coating of the first large particles is thicker than an insulation coating of the second large particles.

As a low loss material, a soft magnetic metal material having a nanocrystal structure has attracted an attention, but Bs tends to be lower in comparison to other soft magnetic metal materials. In addition, in order to increase Bs of the magnetic core, it is necessary to perform high-density packing of a magnetic powder, and thus high-pressure molding is required. In addition, in terms of materials, when using an amorphous material with high Bs, since an influence of magnetostriction is higher and a higher stress is required to perform high-density packing in comparison to a nanocrystalline material from material surface, it is considered that a hysteresis loss increases.

The present inventors found that a low-loss core that is not realized in a magnetic core obtained by simple mixing is realized by controlling the thickness of an insulation coating of first large particles having an amorphous structure and second large particles having a nanocrystal structure, and they accomplished the present invention. That is, it is considered that when making the insulation coating of the first large particles having the amorphous structure be thicker than the insulation coating of the second large particles, a buffer effect was obtained, and as a result, the low-loss core could be realized.

Preferably, T1/T2 is 1.3 to 40, and more preferably 1.3 to 20, in which an average thickness of the insulation coating of the first large particles is set to T1, and an average thickness of the insulation coating of the second large particles is set to T2.

The average thickness T2 of the insulation coating of the second large particles is preferably 5 to 50 nm.

The metal magnetic particles may include a particle group in which a Heywood diameter on the cross-section of the magnetic core is less than 3 μm. In addition, the particle group in which the Heywood diameter is less than 3 μm may include two or more kinds of small particles having coatings different composition to each other.

A magnetic component according to another aspect of the present invention includes the magnetic core described in any one of the aspects. The magnetic core is provided in various magnetic components such as an inductor, a choke coil, a transformer, and a reactor, and contributes to high efficiency of the magnetic component. Note that, the magnetic component is not limited to the magnetic component including the magnetic core, and may be a magnetic component that is not provided with the magnetic core.

For example, a magnetic component according to still another aspect of the present invention is a magnetic component including a magnetic body containing metal magnetic particles. A total area ratio occupied by the metal magnetic particles on a cross-section of the magnetic body is 75% or more. The metal magnetic particles include, first large particles having an amorphous structure and having a Heywood diameter of 3 μm or more on the cross-section of the magnetic body, and second large particles having a nanocrystal structure and having a Heywood diameter of 3 μm or more on the cross-section of the magnetic body. An insulation coating of the first large particles is thicker than an insulation coating of the second large particles.

### BRIEF DESCRIPTION OF THE DRAWINGS

FIG. 1 is a schematic diagram showing a cross-section of a magnetic core according to an embodiment;

FIG. 2A is a graph showing an example of a particle size distribution of metal magnetic particles;

FIG. 2B is a graph showing an example of the particle size distribution of the metal magnetic particles;

FIG. 2C is a graph showing an example of the particle size distribution of the metal magnetic particles;

FIG. 3A is an enlarged schematic view of a cross-section of the magnetic core shown in FIG. 1;

FIG. 3B is an enlarged schematic view of a cross-section of a magnetic core according to a second embodiment;

FIG. 4 is a schematic cross-sectional view showing an example of a powder treatment device that is used when forming an insulation coating on the metal magnetic particles; and

FIG. 5 is a cross-sectional view showing an example of a magnetic component.

### DETAILED DESCRIPTION OF THE PREFERRED EMBODIMENTS

Hereinafter, description is made on the basis of embodiments.

### First Embodiment

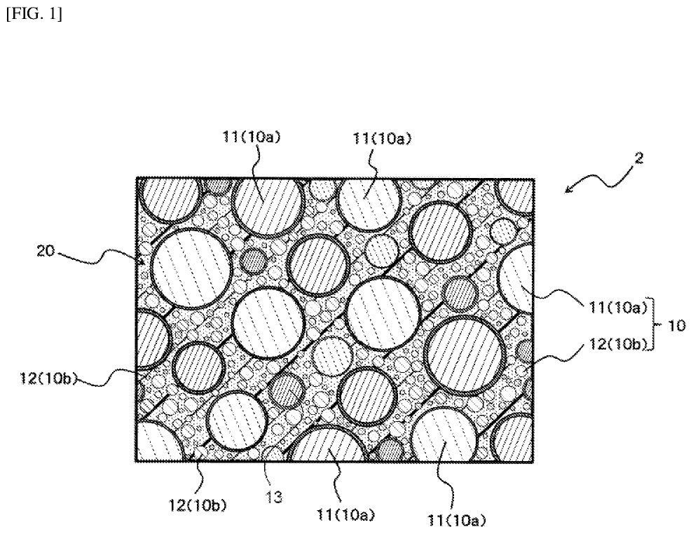

A magnetic core 2 according to an embodiment shown in FIG. 1 may maintain a predetermined shape, and an external size or a shape thereof is not particularly limited. The magnetic core 2 contains at least metal magnetic particles 10 and a resin 20, and the metal magnetic particles 10 are dispersed in the resin 20. That is, the metal magnetic particles 10 are bound through the resin 20, and thus the magnetic core 2 has a predetermined shape.

A total area ratio A0 occupied by the metal magnetic particles 10 on a cross-section of the magnetic core 2 is preferably 75% or more. An upper limit of the total area ratio is not particularly limited, but A0 may be 90% or less or 89% or less from the viewpoint of reducing the core loss. Note that, from the viewpoint of increasing magnetic permeability, A0 is preferably as high as possible. The total area ratio A0 of the metal magnetic particles 10 corresponds to a packing rate of the metal magnetic particles 10 in the magnetic core 2, and may be calculated by performing analysis on the cross-section of the magnetic core 2 by using an electronic microscope such as a scanning electron microscope (SEM) and a scanning transmission electron microscope (STEM).

For example, observation is performed by dividing any cross-section of the magnetic core 2 into a plurality of continuous fields of view, and an area of each of the metal magnetic particles 10 included in each of the fields of view is measured. Then, the sum of the areas of the metal magnetic particles 10 is divided by a total area of the observed fields of view to calculate the total area ratio A0 (%) of the metal magnetic particles 10. In the cross-section analysis, the total area of the fields of view is preferably set to at least 1000000 μm².

In addition, in the cross-section analysis, in a case where a cut-out surface (a surface obtained by cutting out and polishing the magnetic core 2) of an observation sample is less than the total area of the fields of view, after analyzing a predetermined cut-out surface, the cut-out surface may be polished again by 100 μm or more, and the cross-section analysis may be performed again to set the total area of the fields of view to 1000000 μm² or more.

The metal magnetic particles 10 contained in the magnetic core 2 include a first particle group 10a in which a Heywood diameter is 3 μm or more, and preferably further includes a second particle group 10b in which a Heywood diameter is less than 3 μm. Here, the “Heywood diameter” in this embodiment represents a circle equivalent diameter of each of the metal magnetic particles 10 observed on the cross-section of the magnetic core 2. Specifically, an area of each of the metal magnetic particles 10 on the cross-section of the magnetic core 2 is set to S, and the Heywood diameter of each of the metal magnetic particles 10 is expressed by (4S/π)^{1/2}.

In a case where the metal magnetic particles 10 include the first particle group 10a and the second particle group 10b, in the magnetic core 2, a content rate of the first particle group 10a and a content rate of the second particle group 10b are not particularly limited, but from the viewpoint of increasing the magnetic permeability, it is preferable that the content rate of the first particle group 10a is more than the content rate of the second particle group 10b. That is, on the cross-section of the magnetic core 2, when a total area ratio occupied by first particle group 10a is set to AL and a total area ratio occupied by second particle group 10b is set to AS, the area ratio of the metal magnetic particles 10 preferably satisfies a relationship of AL>AS.

When the content rate of the first particle group 10a is set to be larger than the content rate of the second particle group 10b, the magnetic permeability of the magnetic core 2 can be improved. Note that, the sum of AL and AS becomes the total area ratio A0 of the metal magnetic particles 10 (AL+AS=A0), and AL and AS may be measured by a similar method as in A0.

In addition, the metal magnetic particles 10 preferably include two or more particle groups different in an average particle size. For example, the metal magnetic particles 10 may include at least large particles 11 corresponding to the first particle group 10a, but the metal magnetic particles 10 preferably include the large particles 11 and small particles 12, and may include other medium particles 13. The large particles 11, the small particles 12, and the medium particles 13 can be distinguished on the basis of a particle size distribution of the metal magnetic particles 10. The particle size distribution of the metal magnetic particles 10 may be specified by measuring the Heywood diameter of at least 1000 pieces of the metal magnetic particles 10 on any cross-section of the magnetic core 2.

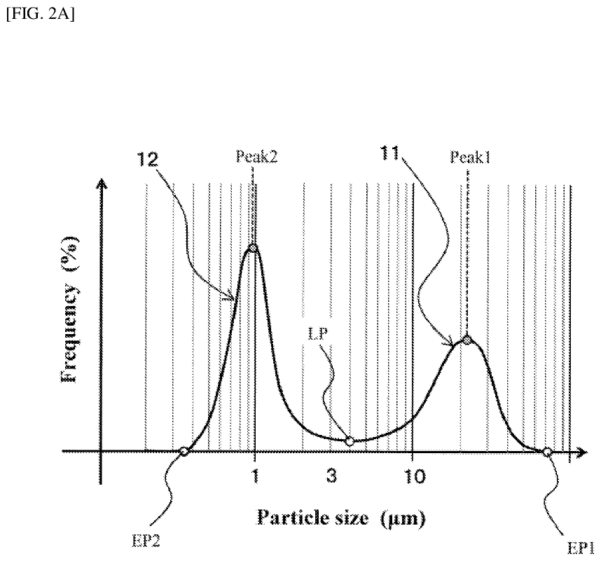

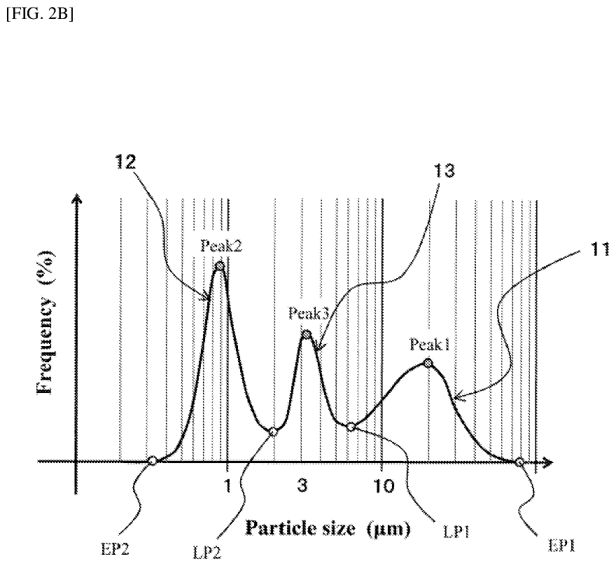

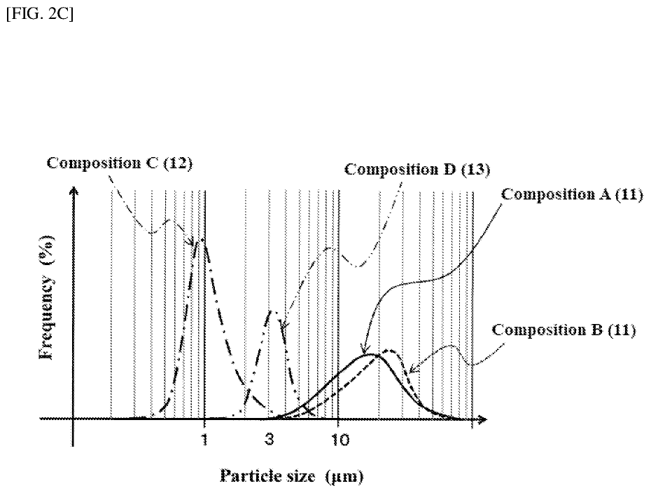

For example, graphs exemplified in FIGS. 2A to 2C are particle size distributions of the metal magnetic particles 10. In the graphs of FIGS. 2A to 2C, the vertical axis represents an area-basis frequency (%), and the horizontal axis is a logarithmic axis representing a particle size (μm) in terms of the Heywood diameter. Note that, the particle size distributions shown in FIGS. 2A to 2C are illustrative only, and the particle size distribution of the metal magnetic particles 10 is not limited to FIGS. 2A to 2C.

In a case where the metal magnetic particles 10 are constituted by two particle groups (large particles and small particles) different in an average particle size, as shown in FIG. 2A, the particle size distribution of the metal magnetic particles 10 has two peaks. In addition, in a case where the metal magnetic particles 10 are constituted by three particle groups (a large particle, a medium particle, and a small particle) different in an average particle size, as shown in FIG. 2B, the particle size distribution of the metal magnetic particles 10 has three peaks.

As shown in FIGS. 2A and 2B, in a case where the particle size distribution of the metal magnetic particles 10 is expressed by a series of distribution curves, a particle group which belongs to a peak located on the largest diameter side (peak located on the rightmost side of the horizontal axis) and in which D20 is 3 μm or more is set as large particles 11, and a particle group which belongs to a peak located on the smallest diameter side (peak located on the leftmost side of the horizontal axis) and in which D80 is less than 3 μm is set as small particles 12. In addition, particles other than the large particles 11 and the small particles 12 are set as medium particles 13.

Here, the “particle group belonging to a peak located on the largest diameter side” represents a particle group included in a range from the bottom (the rightmost end) of the distribution curve to a local minimum point through a peak top point when tracing the distribution curve from the large diameter side (the right side of the graph). That is, in a case of the particle size distribution shown in FIG. 2A, a particle group included in a range from EP1 to LP through Peak 1 corresponds to the “particle group belonging to a peak located on the largest diameter side”. In a case of the particle size distribution shown in FIG. 2B, a particle group included in a range from EP1 to LP1 through Peak 1 corresponds to the “particle group belonging to a peak located on the largest diameter side”.

In addition, D20 represents a Heywood diameter in which an area-basis cumulative frequency is 20%. In the particle size distributions in FIGS. 2A and 2B, D20 of the particle group belonging to Peak 1 is 3 μm or more, and a particle group belonging to Peak 1 corresponds to the large particles 11.

The “particle group belonging to a peak located on the smallest diameter side” represents a particle group included in a range from the bottom (leftmost end) of the distribution curve to a local minimum point through a peak top point when tracing the distribution curve from the small diameter side (the left side of the graph). That is, in a case of the particle size distribution shown in FIG. 2A, a particle group included in a range from EP2 to LP through Peak 2 corresponds to the “particle group belonging to a peak located on the smallest diameter side”. In addition, in a case of the particle size distribution shown in FIG. 2B, a particle group included in a range from EP2 to LP2 through Peak 2 corresponds to the “particle group belonging to a peak located on the smallest diameter side”.

In addition, D80 represents a Heywood diameter in which an area-basis cumulative frequency becomes 80%. In the particle size distributions in FIGS. 2A and 2B, D80 of a particle group belonging to Peak 2 is less than 3 μm, and the particle group belonging to Peak 2 corresponds to the small particles 12.

Note that, in the particle size distribution shown in FIG. 2B, a particle group from LP1 to LP2 through Peak 3 is a particle group belonging to Peak 3. In the particle group belonging to Peak 3, D20 is less than 3 μm and D80 is 3 μm or more. That is, the particle group belonging to Peak 3 corresponds to medium particles 13 which correspond to neither the large particles 11 nor the small particles 12.

In a case where the metal magnetic particles 10 include two or more particle groups different in an average particle size, the small particles 12, and/or the medium particles 13 may have the same particle composition as in the large particles 11, or may have a particle composition different from the particle composition of the large particles 11. Note that, “different in a particle composition” represents a case where kinds of constituent elements contained in a particle main body are different from each other, or a case where content ratios of the constituent elements are different from each other even though kinds of the constituent elements match each other. The constituent elements represent elements contained in the particle main body in a ratio of 1 at % or more. That is, it is assumed that elements other than impurity elements among the elements contained in the particle main body are referred to as the constituent elements.

In a case where the small particles 12 and/or the medium particles 13 have a particle composition different from the particle composition of the large particles 11, the metal magnetic particles 10 may be classified by using composition analysis and particle size analysis in combination. Specifically, at the time of observing the cross-section of the magnetic core 2 by an electron microscope, the composition of each of the metal magnetic particles 10 included in an observation field of view is analyzed by using an energy dispersive X-ray analyzer (EDX device) or an electron probe microanalyzer (EPMA), and the metal magnetic particles 10 are classified on the basis of the composition. Then, a plurality of distribution curves are obtained by measuring the Heywood diameter of the metal magnetic particles 10 belonging to each composition.

For example, in a case where the metal magnetic particles 10 are constituted by four particle groups different in a particle composition, four distribution curves are obtained as shown in FIG. 2C. In the particle size distribution in FIG. 2C, a distribution curve of a particle group having Composition A is shown as a solid line, a distribution curve of a particle group having Composition B is shown as a dotted line, a distribution curve of a particle group having Composition C is shown as a one-dotted chain line, and a distribution curve of a particle group having Composition D is shown as a two-dotted chain line.

As shown in FIG. 2C, in a case where the particle size distributions of the metal magnetic particles 10 are expressed by a plurality of distribution curves corresponding to compositions, a particle group in which D20 is 3 μm or more is set as the large particles 11, a particle group in which D80 is less than 3 μm is set as the small particles 12, and particle groups other than the large particles 11 and the small particles 12 are set as the medium particles 13. That is, in FIG. 2C, the particle group having Composition A and the particle group having Composition B correspond to the large particles 11, the particle group having Composition C corresponds to the small particles 12, and the particle group having Composition D corresponds to the medium particles 13.

As described above, D20 of the large particles 11 is preferably 3 μm or more, and the Heywood diameter of the large particles 11 is preferably 3 μm or more in any particle. In addition, an average value (arithmetic average diameter) of the Heywood diameter of the large particles 11 is not particularly limited, and is preferably 5 to 40 μm, and more preferably 10 to 35 μm as an example. D80 of the small particles 12 is preferably less than 3 μm, and the Heywood diameter of the small particles 12 is preferably less than 3 μm in any particle. In addition, an average value (arithmetic average diameter) of the Heywood diameter of the small particles 12 is not particularly limited, and is preferably 2 μm or less, and more preferably 0.2 μm or more and less than 2 μm as an example.

As described above, when a total area ratio occupied by the large particles 11 on the cross-section of the magnetic core 2 is set as AL, and a total area ratio occupied by the small particles 12 on the cross-section of the magnetic core 2 is set as AS, AL is preferably larger than AS from the viewpoint of increasing the magnetic permeability (AL>AS). Note that, in this embodiment, even in a case where AL is equal to or less than AS, an effect of reducing the core loss can be realized.

Specifically, a ratio (AL/A0) of the total area of the large particles 11 to the total area of the metal magnetic particles 10 is not particularly limited, but may be 15% to 95%, and from the viewpoint of increasing the magnetic permeability, the ratio is preferably more than 50% and equal to or less than 90%, and more preferably 60% to 88%.

In addition, a ratio (AS/A0) of the total area of the small particles 12 to the total area of the metal magnetic particles 10 may be 5% to 85%, and the ratio is preferably 5% or more and less than 50% from the viewpoint of increasing the magnetic permeability, and more preferably 10% to 40%. When the magnetic core 2 contains the small particles 12 at the above-described ratio in combination with the large particles 11, the magnetic permeability can be improved. Note that, AL and AS described above may be measured by a similar method as in A0.

The metal magnetic particles 10 may include medium particles 13, and in a case of including the medium particles 13, an average value (arithmetic average diameter) of a Heywood diameter of the medium particles 13 is not particularly limited, and is preferably 3 to 5 μm as an example. In addition, a ratio (AM/A0) of the total area (AM) of the medium particles 13 to the total area (A0) of the metal magnetic particles 10 is preferably 30% or less, and more preferably 5% to 20%.

In addition, an average circularity of the large particles 11 on the cross-section of the magnetic core 2 is preferably 0.90 or more, and more preferably 0.95 or more. As the average circularity of the large particles 11 is higher, a withstand voltage and DC bias characteristics can be further improved. Note that, the circularity of the each of the large particles 11 is expressed by 2(πS_{L})^{1/2}/L when an area of each of the large particles 11 on the cross-section of the magnetic core 2 is set as S_{L}, and a peripheral length of the large particle 11 is set as L. The circularity of a perfect circle is 1, and a spheroidicity of a particle becomes higher as the circularity is closer to 1. An average circularity of the large particles 11 is preferably calculated by measuring the circularity of at least 100 large particles 11.

Note that, the average circularity of the small particles 12 and the average circularity of the medium particles 13 are not particularly limited, but the small particles 12 and the medium particles 13 preferably have a high average circularity as in the large particles 11. Specifically, any of the average circularity of the small particles 12 and the average circularity of the medium particles 13 is preferably 0.80 or more.

Note that, in this embodiment, the methods shown in FIGS. 2A to 2C are suggested as a method of classifying the metal magnetic particles 10 into the large particles 11, the small particles 12, and the like, but it is preferable to use the classification method shown in FIG. 2A or 2B in a case where the small particles 12 have the same particle composition as in the large particles 11, and it is preferable to use the classification method shown in FIG. 2C in a case where the small particles 12 have a particle composition different from the particle composition of the large particles 11.

In the magnetic core 2 of this embodiment, the large particles 11 can be subdivided into two kinds of particle groups different in an intragranular substance state. Specifically, the large particles 11 include first large particles 11a having an amorphous structure and second large particles 11b having a nanocrystal structure.

Here, the “nanocrystal structure” represents a crystal structure in which the degree of amorphization X is less than 85%, and an average crystallite diameter is 0.5 to 30 nm. Note that, the “amorphous structure” represents a crystal structure in which the degree of amorphization X is 85% or more, and includes a structure consisting of a hetero-amorphous substance.

The structure consisting of the hetero amorphous substances represents a structure in which an initial fine crystal exists in the amorphous substance, and an average diameter of the initial fine crystal in the hetero amorphous structure is preferably 0.1 to 10 nm. Note that, in this embodiment, “crystalline structure” represents a crystal structure in which the degree of amorphization X is less than 85%, and the average crystallite diameter is 100 nm or more.

An intragranular crystal structure (that is, the degree of amorphization X or the crystallite size) can be specified by structure analysis using various electron microscopes such as a SEM, a TEM, and a STEM, electron beam diffraction, X-ray diffraction (XRD), electron backscattering diffraction (EBSD), or the like. For example, in an orientation mapping image of the EBSD, a bright field image of the electron microscope, and the like, a crystalline portion and an amorphous portion can be visually identified, and the degree of amorphization X and the average crystallite diameter can be measured by analyzing the images. In addition, in a case where spots caused by crystals are not confirmed in the electron beam diffraction, measurement target particles can be specified when the measurement target particles have an amorphous structure.

Note that, the degree of amorphization X (unit: %) is expressed by a relationship of X=(P_{A}/(P_{C}+P_{A}))×100 when a ratio of crystals is set as P_{C}, and a ratio of an amorphous substance is set as P_{A}. In a case of calculating the degree of amorphization X by using the XRD, the ratio P_{C} of the crystals may be measured as a crystalline scattering integrated intensity I_{C}, and the ratio P_{A} of the amorphous substance may be measured as an amorphous scattering integrated intensity Ia. In a case of calculating the degree of amorphization X by using the EBSD or the electron microscope, P_{C} may be measured as an area ratio of a crystal portion in a grain, and P_{A} may be measured as an area ratio of an amorphous portion.

In a case of classifying the large particles 11 by the electron microscope, as described above, structure analysis for specifying a substance state is performed on the large particles 11 included in an observation field of view, but the structure analysis may be performed by arbitrarily selecting some large particles 11 in the observation field of view. In this case, large particles 11 for which the substance state is specified may be regarded as analysis particles, and the other large particles 11 having the same composition as in the analysis particles may be regarded to have the same substance state as in the analysis particles.

For example, Fe—Co—B—P—Si—Cr-based first large particles 11a and Fe—Si—B—Nb—Cu-based second large particles 11b exist as the large particles 11, these can be identified by area analysis using EDX. In addition, for example, structure analysis is performed by selecting any analysis target particle from the Fe—Co—B—P—Si—Cr-based particle group, and when it can be specified that the analysis target particle has an amorphous structure, any of the Fe—Co—B—P—Si—Cr-based particle group can be regarded to have the amorphous structure.

Similarly, structure analysis is performed by selecting any analysis target particle from the Fe—Si—B—Nb—Cu-based particle group, and when it can be specified that the analysis target particle has a nanocrystal structure, any of the Fe—Si—B—Nb—Cu-based particle group can be regarded to have the nanocrystal structure.

Any of the amorphous first large particles 11a and the nanocrystalline second large particles 11b are composed of a soft magnetic alloy, and an alloy composition thereof is not particularly limited. The first large particles 11a and the second large particles 11b have substance states different from each other, but may have the same alloy composition or may have alloy compositions different from each other.

Examples of a soft magnetic alloy having the nanocrystal structure or a soft magnetic alloy having the amorphous structure include an Fe—Si—B-based alloy, an Fe—Si—B—C-based alloy, an Fe—Si—B—C—Cr-based alloy, an Fe—Nb—B-based alloy, an Fe—Nb—B—P-based alloy, an Fe—Nb—B—Si-based alloy, an Fe—Co—P—C-based alloy, an Fe—Co—B-based alloy, an Fe—Co—B—Si-based alloy, an Fe—Si—B—Nb—Cu-based alloy, an Fe—Si—B—Nb—P-based alloy, an Fe—Co—B—P—Si-based alloy, an Fe—Co—B—P—Si—Cr-based alloy, and the like.

A total area ratio occupied by the amorphous first large particles 11a on the cross-section of the magnetic core 2 is set as AL₁, and a ratio of the total area ratio (AL₁) of the first large particles 11a to the total area (A0) of the metal magnetic particles 10 is expressed as AL₁/A0. Similarly, a total area ratio occupied by the nanocrystalline second large particles 11b on the cross-section of the magnetic core 2 is set as AL₂, and a ratio of the total area ratio (AL₂) of the second large particles 11b to the total area ratio (A0) of the metal magnetic particles 10 is expressed as AL₂/A0. Any of AL₁/A0 and AL₂/A0 is not particularly limited, but is preferably 3% or more, more preferably 4% to 78%, and still more preferably 7% to 44%.

In addition, each of AL₁/(AL₁+AL₂) and AL₂/(AL₁+AL₂) is not particularly limited, but may be set, for example, within a range of 4% to 96%. AL₁/(AL₁+AL₂) is more preferably 50% to 96% from the viewpoint of obtaining more excellent DC bias characteristics, and AL₂/(AL₁+AL₂) is more preferably 50% to 90% from the viewpoint of further lowering the core loss.

From the viewpoint of improving the core loss and the DC bias characteristics with balance, and enhancing the effect of improving the core loss, AL₁/(AL₁+AL₂) is preferably 10% to 94%, and more preferably 18% to 85%. Note that, AL₁ and AL₂ may be measured by a similar manner as in the total area ratio A0 of the metal magnetic particles 10.

In a case where the metal magnetic particles 10 include the small particles 12, a composition of the small particles 12 is not particularly limited. The small particles 12 may have the amorphous structure or the nanocrystal structure, but it is preferable to have the crystalline structure from the viewpoint of a saturation magnetic flux.

Examples of a soft magnetic metal having the crystalline structure include pure iron such as carbonyl iron, Co, an Fe—Ni-based alloy, an Fe—Si-based alloy, an Fe—Si—Cr-based alloy, an Fe—Si—Al-based alloy, an Fe—Si—Al—Ni-based alloy, an Fe—Ni—Si—Co-based alloy, an Fe—Co-based alloy, an Fe—Co—V-based alloy, an Fe—Co—Si-based alloy, an Fe—Co—Si—Al-based alloy, a Co-based alloy, and the like.

Particularly, the small particles 12 are preferably pure iron particles, Fe—Ni-based alloy particles, Fe—Co-based alloy particles, Fe—Si-based alloy particles, or Co particles.

In addition, in a case where the metal magnetic particles 10 include the medium particles 13, a composition of the medium particles 13 is not particularly limited. For example, the medium particles 13 may have the crystalline structure, but it is preferable to have the nanocrystal structure or the amorphous structure from the viewpoint of lowering coercivity.

Note that, the composition of the metal magnetic particles 10 can be analyzed, for example, by using an EDX device or an EPMA attached to an electron microscope. In a case where the first large particles 11a and the second large particles 11b have particle compositions different from each other, the first large particles 11a and the second large particles 11b can be distinguished by area analysis using the EDX device or the EPMA. In addition, the composition of the metal magnetic particles 10 may be analyzed by using a three-dimensional atom probe (3DAP).

In a case of using the 3DAP, an average composition can be measured by setting a small region (for example, a region of @20 nm×100 nm) at the inside of the metal magnetic particles as a measurement target, a composition of a particle main body can be specified by excluding a resin component contained in the magnetic core 2, and an influence due to oxidation of a particle surface or the like.

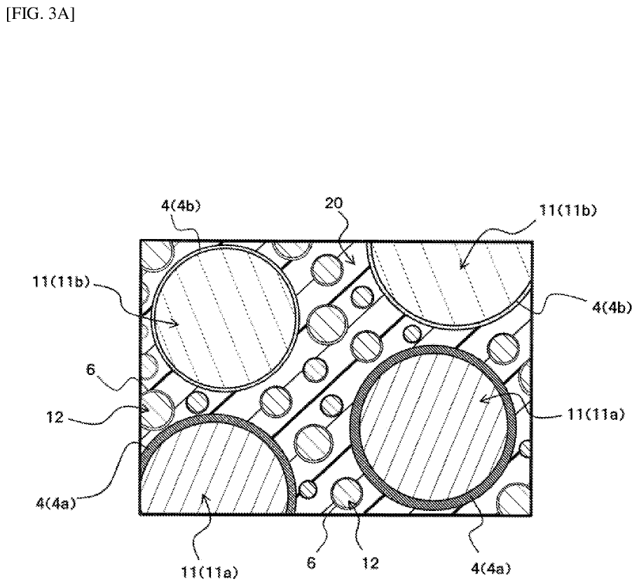

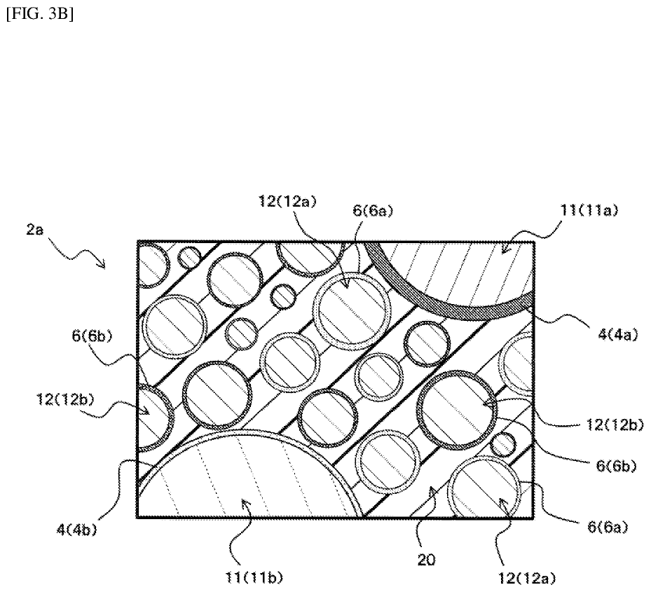

As shown in FIG. 3A, each of the first large particles 11a includes an insulation coating 4a that covers a particle surface, and each of the second large particles 11b includes an insulation coating 4b that covers a particle surface. Any of the insulation coating 4a and the insulation coating 4b may cover the entirety of the particle surface, or may cover only a part of the particle surface. Each of the insulation coating 4a and the insulation coating 4b preferably covers 80% or more of the particle surface observed on the cross-section of the magnetic core 2.

In addition, any of the insulation coating 4a and the insulation coating 4b may have a deviation in a thickness in a single particle, but it is preferable to have a uniform thickness as can as possible. For example, an arithmetic average height Ra in a contour curve of a coating surface is preferably 0.5 to 100 nm. Ra is a kind of a line roughness parameter. An outermost surface portion of the insulation coating (4a or 4b) observed on the cross-section of the magnetic core 2 may be specified as the contour curve, and Ra may be calculated. For example, when obtaining Ra in any metal particle, the cross-section may be observed and evaluated by a transmission electron microscope. With regard to an evaluation method, when observing the cross-section by the transmission electron microscope, an evaluation may be made by a contour curve of 5 μm or more.

A material of the insulation coating 4a and a material of the insulation coating 4b are not particularly limited, and the insulation coating 4a and the insulation coating 4b may have the same composition or may be compositions different from each other. For example, the insulation coating 4a and the insulation coating 4b may include a coating due to oxidation of the particle surface, and/or a coating containing an inorganic material such as BN, SiO₂, MgO, Al₂O₃, phosphate, silicate, borosilicate, bismuthate, and various kinds of glass.

From the viewpoint of suppressing a decrease in resistivity of the magnetic core 2, any of the insulation coating 4a and the insulation coating 4b preferably includes an oxide glass coating containing one or more kinds of elements selected among P, Si, Bi, and Zn. In the oxide glass coating, when a total amount of elements excluding oxygen among elements contained in the coating is set to 100 wt %, it is preferable that the total amount of one or more kinds of elements selected among P, Si, Bi, and Zn is the greatest, and more preferably 50 wt % or more, and still more preferably 60 wt % or more.

Examples of the oxide glass coating include a phosphate (P₂O₅)-based glass coating, a bismuthate (Bi₂O₃)-based glass coating, a borosilicate (B₂O₃—SiO₂)-based glass coating, and the like.

Examples of the phosphate-based glass include P—Zn—Al—O-based glass, P—Zn—Al—R—O-based glass (“R” is one or more kinds of elements selected from alkali metals), and the like, and 50 wt % or more of P₂O₅ is preferably contained in the phosphate-based glass coating.

Examples of the bismuthate-based glass include Bi—Zn—B—Si—O-based glass, Bi—Zn—B—Si—Al—O-based glass, and the like, and 50 wt % or more of Bi₂O₃ is preferably contained in the bismuthate-based glass coating.

Examples of the borosilicate-based glass include Ba—Zn—B—Si—Al—O-based glass, and the like, and 10 wt % or more of B₂O₃ is preferably contained in the borosilicate-based glass coating.

Any of the insulation coating 4a and the insulation coating 4b may have a single-layer structure or may have a multilayer structure. Examples of the multilayer structure include a stacked structure including an oxide layer of a particle surface and an oxide glass layer that covers the oxide layer. In a case where the insulation coatings 4a and/or 4b have the multilayer structure, a total thickness of respective layers is set as the thickness of the insulation coating. In addition, a composition of the insulation coatings 4a and 4b can be analyzed, for example, by the EDX, the EPMA, or electron energy loss spectroscopy (EELS).

In the magnetic core 2 of this embodiment, the insulation coating 4a of the first large particles 11a is thicker than the insulation coating 4b of the second large particles 11b. When the first large particles 11a having the amorphous structure includes an insulation coating thicker than an insulation coating of the second large particles 11b having the nanocrystal structure, the core loss can be reduced while maintaining good DC bias characteristics.

When an average thickness of the insulation coating 4a of the first large particles 11a is set as T1, and an average thickness of the insulation coating 4b of the second large particles 11b is set as T2, T1/T2 is more than 1.0. From the viewpoint of reducing the core loss, T1/T2 is preferably 1.3 or more, more preferably 1.5 or more, and still more preferably 2.0 or more. An upper limit of T1/T2 is not particularly limited, but from the viewpoint of insulation properties of a powder, T1/T2 is preferably 40 or less, preferably 30 or less, or preferably 20 or less.

In addition, from the viewpoint of the magnetic permeability of the magnetic core, T1 is preferably 200 nm or less. From the viewpoint of reducing the core loss while securing insulation, T2 is preferably 5 nm or more. An upper limit of T2 is determined on the basis of T1, and may be set, for example, to 150 nm or less, 100 nm or less, or 50 nm or less.

T1 may be calculated by observing the cross-section of the magnetic core 2 with various electron microscopes, and it is preferable to calculate T1 by measuring the thickness of the insulation coating 4a with respect to at least 10 first large particles 11a. T2 may be calculated by a similar method as in T1. Note that, large particles 11 which do not include the insulation coating 4 may be contained in the magnetic core 2.

In a case where the metal magnetic particles 10 include the small particles 12, the small particles 12 may not include an insulation coating, but each of the small particles 12 preferably includes an insulation coating 6 that covers a particle surface. A material of the insulation coating 6 is not particularly limited, for example, the insulation coating 6 may be a coating (oxide coating) due to oxidation of a surface of the small particle 12, or a coating containing an inorganic material such as BN, SiO₂, MgO, Al₂O₃, phosphate, silicate, borosilicate, bismuthate, and various kinds of glass, and it is preferable to include an oxide glass coating. In addition, the insulation coating 6 may have a single-layer structure, or may have a structure in which two or more coatings are stacked. An average thickness of the insulation coating 6 is not particularly limited, and for example, the average thickness is preferably 5 to 100 nm, and more preferably 5 to 50 nm.

In a case where the metal magnetic particles 10 include the medium particles 13, the medium particles 13 preferably include an insulation coating that covers a particle surface in a similar manner as in the other particle groups. A composition of the insulation coating of the medium particles 13 is not particularly limited, and may have the same composition as in the insulation coating 4a or 4b of the large particles 11, or may have a composition different from the composition of the insulation coating 4a or 4b of the large particles 11. An average thickness of the insulation coating of the medium particles 13 is not particularly limited, and for example, the average thickness is preferably 5 to 200 nm, and more preferably 10 to 50 nm.

The insulation coating 6 of the small particles 12 and the insulation coating of the medium particles 13 may cover the entirety of the particle surface as in the insulation coating 4 or may cover only a part of the particle surface. Each of the insulation coatings preferably covers 80% or more of the particle surface observed on the cross-section of the magnetic core 2. Note that, the small particles 12 or the medium particles 13 which do not include the insulation coating may be contained in the magnetic core 2.

For example, the resin 20 shown in FIG. 3 functions an insulating binder that fixes the metal magnetic particles 10 in a predetermined dispersed state. A material of the resin 20 is not particularly limited, and the resin 20 preferably includes a thermosetting resin such as an epoxy resin.

Note that, the magnetic core 2 may contain a modifier for suppressing contact between soft magnetic metal particles. As the modifier, polymer materials such as polyethylene glycol (PEG), polypropylene glycol (PPG), and polycaprolactone (PCL) can be used, and polymeric materials having a polycaprolactone structure are preferably used.

Examples of a polymer having the polycaprolactone structure include raw materials of urethane such as polycaprolactone diol and polycaprolactone tetraol, and part of polyesters. The content of the modifier is preferably 0.025 to 0.500 wt % with respect to the total amount of the magnetic core 2. It is considered that the modifier exists in a state of being absorbed to coat the surface of the metal magnetic particles 10. Hereinafter, an example of a method of manufacturing the magnetic core 2 according to this embodiment is described.

First, a raw material powder including the first large particles 11a and a raw material powder including the second large particles 11b are manufactured as a raw material powder of the metal magnetic particles 10. In addition, in a case of adding the small particles 12 or the medium particles 13 to the magnetic core 2, a raw material powder including the small particles 12 and a raw material powder including the medium particles 13 are prepared.

A method of manufacturing each of the raw material powders is not particularly limited, and an appropriate manufacturing method may be used in corresponding to a desired particle composition. For example, the raw material powders may be prepared by an atomization method such as a water atomization method and a gas atomization method. Alternatively, the raw material powders may be prepared by a synthesis method such as a CVD method using at least one or more kinds among evaporation, reduction, and thermal decomposition of metal salts. In addition, the raw material powders may be prepared by using an electrolytic method or a carbonyl method, or may be prepared by pulverizing starting alloys having a ribbon shape or a thin plate. Particularly, a raw material powder including the first large particles 11a and a raw material powder including the second large particles 11b are preferably manufactured by a rapid-cooling gas atomization method.

A particle size of each of the raw material powders can be adjusted by manufacturing conditions of the powders or various classification methods. In addition, a heat treatment for controlling the crystal structure of the second large particles 11b is preferably performed on the raw material powder that becomes the nanocrystalline second large particles 11b.

Note that, in a case where the small particles 12 is set to have the same composition as in the large particles 11 (the first large particles 11a and/or the second large particles 11b), a raw material powder having a wide particle size distribution may be manufactured, and the raw material powder may be classified to obtain a raw material powder including the large particles 11 and a raw material powder including the small particles 12.

Next, a coating forming treatment is performed on each of the raw material powders. In a case of manufacturing the magnetic core by using metal magnetic powders including a plurality of particle groups, typically, a plurality of raw material powders are mixed and then the coating forming treatment is performed at a time on the mixed powder to simplify a manufacturing process. However, when performing the coating forming treatment on the mixed powder, there is a high possibility that insulation coatings of respective particle groups have a similar thickness (that is, T1≈T2).

In this embodiment, in order to make the insulation coating 4a of the first large particles 11a thicker than the insulation coating 4b of the second large particles 11b (that is, to realize a relationship of T1>T2), it is preferable that the coating forming treatment is individually performed on the first large particles 11a and the second large particles 11b.

Examples of a coating forming treatment method include a heat treatment, a phosphate treatment, mechanical alloying, a silane coupling treatment, hydrothermal synthesis, and the like, and an appropriate coating forming treatment may be selected in correspondence with the kind of the insulation coating to be formed.

For example, in a case where the insulation coating 4a and/or the insulation coating 4b include the oxide glass coating, the oxide glass coating is preferably formed by a mechano-chemical method using a mechano-fusion device. Specifically, in a coating forming treatment by the mechano-chemical method, a raw material powder including large particles, and a powder-shaped coating material including a constituent element of an insulation coating are introduced into a rotary rotor of the mechano-fusion device, and the rotary rotor is caused to rotate.

A press head is provided inside the rotary rotor, and when the rotary rotor is caused to rotate, a mixture of the raw material powder and the coating material is compressed in a gap between an inner wall surface of the rotary rotor and the press head, and friction heat occurs. Due to the friction heat, the coating material is softened, and is fixed to a surface of the large particles due to a compression operation, and the oxide glass coating is formed.

Note that, the thickness of the insulation coating 4a and the thickness of the insulation coating 4b may be controlled on the basis of a mixing ratio of the coating material, a rotation speed, treatment time, and the like.

In a case of forming the insulation coating 6 with respect to the small particles 12, it is preferable to form the insulation coating 6 by mixing a raw material powder including the small particles 12 and a powder-shaped coating material including a constituent element of the insulation coating 6 while applying mechanical impact energy to the resultant mixture, and it is more preferable to form the insulation coating 6 by mixing the raw material powder and the coating material while applying impact, compression, and shear energy to the resultant mixture.

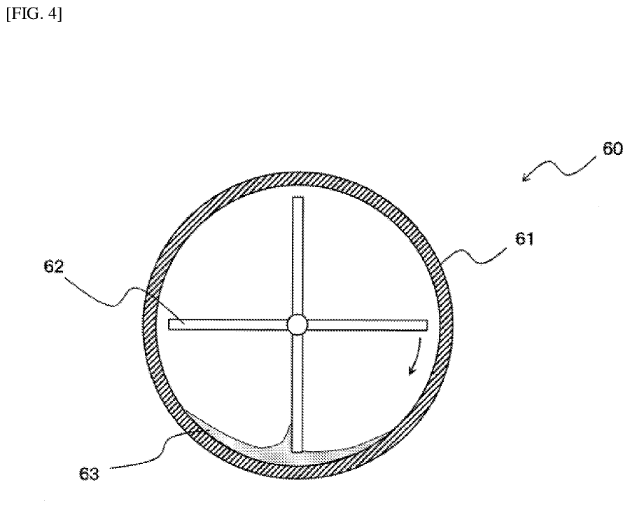

In the coating forming treatment, as a device capable of applying mechanical energy to a powder, a powder treatment device such as a planetary ball mill and Nobilta manufactured by HOSOKAWA MICRON CORPORATION can be used. For example, in a coating forming treatment performed on the small particles 12, a powder treatment device 60 capable of performing mixing at a high rotation speed as shown in FIG. 4 can be used.

The powder treatment device 60 has a cylindrical cross-section and includes a chamber 61 in which a rotatable blade 62 is provided inside the chamber 61. A raw material powder including the small particles 12 and a coating material are put into the chamber 61, and the blade 62 is caused to rotate at a rotational speed of 2000 to 6000 rpm, thereby applying mechanical impact, compression, and shear energy to a mixture 63 of the raw material powder and the coating material. When using the powder treatment device 60, particularly, even in the small particles 12 having a small particle size, the insulation coating 6 can be formed on the particle surface.

In a case of using the medium particles 13 including an insulation coating, the medium particles 13 may be mixed with the first large particles 11a or the second large particles 11b and may be subjected to the coating forming treatment in combination with the first large particles 11a or the second large particles 11b to form the insulation coating on surfaces of the medium particles 13. Alternatively, the coating forming treatment may be individually performed on only the raw material powder of the medium particles 13.

Hereinafter, a method of manufacturing the magnetic core 2 by using respective raw material powders of the metal magnetic particle 10 is described. First, respective raw material powders on which the insulation coating is formed and a resin raw material (thermosetting resin or the like) are kneaded to obtain a resin compound. In the kneading process, various kneaders such as a kneader, a planetary mixer, a rotation/revolution mixer, and a twin-screw extruder may be used, and a modifier, a preservative, a dispersant, a non-magnetic powder, or the like may be added to the resin compound.

Next, the resin compound is filled in a press mold and compression molding is performed to obtain a green compact. A molding pressure at this time is not particularly limited, and is preferably set to, for example, 1250 to 2000 MPa. Note that, a total area ratio of the metal magnetic particles 10 in the magnetic core 2 can be controlled by an addition amount of the resin 20, but can also be controlled by the molding pressure. In a case of using the thermosetting resin as the resin 20, the green compact is maintained at 100° C. to 200° C. for 1 to 5 hours to harden the thermosetting resin. The magnetic core 2 shown in FIG. 1 is obtained by the above-described processes.

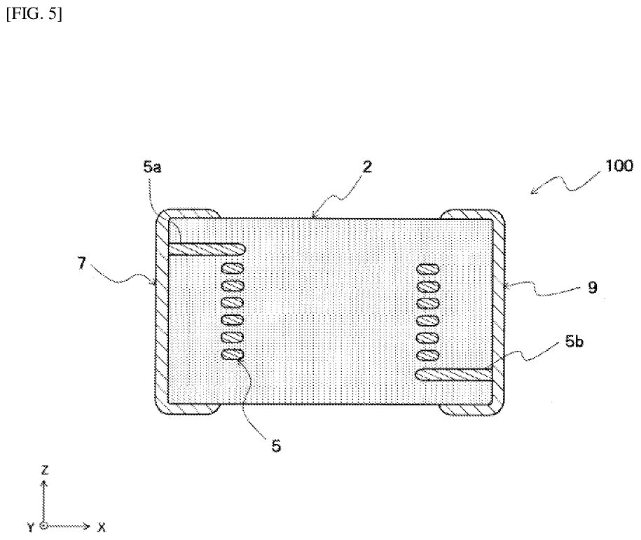

Although not particularly limited, for example, the magnetic core 2 according to this embodiment is applicable to various magnetic components such as an inductor, a choke coil, a transformer, and a reactor. For example, a magnetic component 100 shown in FIG. 5 is an example of a magnetic component including the magnetic core 2.

In the magnetic component 100 shown in FIG. 5, an element body is constituted by the magnetic core 2 shown in FIG. 1. A coil 5 is embedded inside the magnetic core 2 that is the element body, and end portions 5a and 5b of the coil 5 are respectively drawn to end surfaces of the magnetic core 2. In addition, a pair of external electrodes 7 and 9 are respectively formed on the end surfaces of the magnetic core 2, and the pair of external electrodes 7 and 9 are respectively electrically connected to the end portions 5a and 5b of the coil 5. Note that, in a case where the coil 5 is embedded inside the magnetic core 2 as in the magnetic component 100, it is assumed that the area ratios of the metal magnetic particles 10 such as A0, AL (AL) and AL₂), and AS are analyzed in fields of view where the coil 5 does not come into sight.

The magnetic component including the magnetic core 2 is not limited to an aspect as shown in FIG. 5, and may be a magnetic component obtained by winding a wire around the surface of the magnetic core having a predetermined shape (for example, a ring shape or a drum shape) in a predetermined number of turns. The application of the magnetic component that is not limited to the magnetic component 100 shown in FIG. 5 is not particularly limited, but examples thereof include magnetic components (for example, a choke coil, a reactor, and the like) for applications with a low frequency of approximately 400 kHz or less, and particularly, in a case of the low-frequency applications, the effect of reducing the core loss is large. Note that, the magnetic component is not limited to the magnetic component including the magnetic core, and may be a magnetic component that is not provided with the magnetic core.

### (Summary of First Embodiment)

The magnetic core 2 of this embodiment contains the metal magnetic particles 10 and the resin 20, and the total area ratio A0 of the metal magnetic particles 10 appear on the cross-section of the magnetic core 2 is 75% or more. The metal magnetic particles 10 include the first large particles 11a having the amorphous structure, and the second large particles 11b having the nanocrystal structure, and the insulation coating 4a of the first large particles 11a is thicker than the insulation coating 4b of the second large particles 11b.

Since the magnetic core 2 has the above-described characteristics, the core loss can be reduced while maintaining good DC bias characteristics. Specifically, the following facts have been clarified by experiments conducted by the present inventors.

When comparing a magnetic core containing particles having the nanocrystal structure as a main powder (hereinafter, such magnetic core may be referred to as a nanocrystalline magnetic core), and a magnetic core containing particles having the amorphous structure as a main powder (hereinafter, such magnetic core may be referred to as an amorphous magnetic core) with each other, the core loess is lower in the nanocrystalline magnetic core in comparison to the amorphous magnetic core, and the DC bias characteristics are more excellent in the amorphous magnetic core in comparison to the nanocrystalline magnetic core. However, when simply mixing the particles having the amorphous structure and the particles having the nanocrystal structure, the core loss can only be obtained as a value calculated from the mixing ratio.

In the magnetic core 2 of this embodiment, the first large particles 11a which include the relatively thick insulation coating 4a and have the amorphous structure, and the second large particles 11b which include the relatively thin insulation coating 4b and have the nanocrystal structure are mixed. In the magnetic core 2 of this embodiment, the core loss can be effectively reduced while maintaining the DC bias characteristics in a satisfactory manner.

In addition, in this embodiment, even though high-pressure molding of the magnetic powder is performed in order to increase Bs of the magnetic core 2, since the insulation coating 4a of the first large particles 11a having the amorphous structure is made to be thicker than the insulation coating 4b of the second large particles 11b having the nanocrystal structure, the core loss can be further reduced while securing high magnetic permeability (for example, magnetic permeability of 20 or more, 25 or more, 30 or more, or 35 or more).

### Second Embodiment

In a second embodiment, a magnetic core 2a shown in FIG. 3B is described. Note that, in the second embodiment, description of a configuration common to the first embodiment is omitted, and the same reference number as in the first embodiment is used.

As shown in FIG. 3B, in the magnetic core 2a of the second embodiment, the first large particles 11a having the amorphous structure, and the second large particles 11b having the nanocrystal structure are mixed, and the insulation coating 4a of the first large particles 11a is thicker than the insulation coating 4b of the second large particles 11b. Accordingly, even in the magnetic core 2a of the second embodiment, a similar operational effect as in the magnetic core 2 of the first embodiment is obtained.

Two or more kinds of small particles 12 different in a composition of the insulation coating 6 are contained in the magnetic core 2a. In other words, the small particles 12 included in the metal magnetic particles 10 can be subdivided into two or more kinds of small particle groups on the basis of a coating composition. Specifically, the small particles 12 include at least first small particles 12a including a first insulation coating 6a and second small particles 12b including a second insulation coating 6b having a composition different from a composition of the first insulation coating 6a, and may further include third small particles 12c to n^{th} small particles 12x having a coating composition different from that of the other small particle groups. n represents the number of small particle groups in a case of subdividing the small particles 12 on the basis of the coating composition, and an upper limit of n is not particularly limited. From the viewpoint of simplifying manufacturing processes, n is preferably 4 or less.

Here, “different in a coating composition” represents that the kinds of constituent elements contained in the insulation coating 6 are different from each other, and the constituent elements of the insulation coating 6 represent elements contained in the insulation coating 6 by 1 at % or more when a total content ratio of elements other than oxygen and carbon among elements contained in the insulation coating 6 is set to 100 at %. The composition of the insulation coating 6 may be analyzed by area analysis or point analysis using the EDX device or the EPMA.

A material of the insulation coatings 6 (the first insulation coating 6a, the second insulation coating 6b, and the third insulation coating 6c to the n^{th} insulation coating 6x) included in the small particles 12 is not particularly limited. For example, each of the insulation coatings 6 may be set as a coating (oxide coating) due to oxidation of surfaces of the small particles 12, or a coating containing an inorganic material such as BN, SiO₂, MgO, Al₂O₃, phosphate, silicate, borosilicate, bismuthate, and various kinds of glass. It is preferable that the insulation coating 6 includes an oxide glass coating. Examples of the oxide glass include silicate (SiO₂)-based glass, phosphate (P₂O₅)-based glass, bismuthate (Bi₂O₃)-based glass, borosilicate (B₂O₃—SiO₂)-based glass, and the like. The first insulation coating 6a and the second insulation coating 6b may have compositions different from each other, and a combination of coating compositions is not particularly limited. For example, as a combination of the first insulation coating 6a and the second insulation coating 6b, a combination of a P—O-based glass coating and a P—Zn—Al—O-based glass coating, a combination of a Bi—Zn—B—Si—O-based glass coating and an Si—O-based glass coating, or a combination of a Ba—Zn—B—Si—Al—O-based glass coating and an Si—O-based glass coating is preferable, and the combination of the Ba—Zn—B—Si—Al—O-based glass coating and the Si—O-based glass coating is more preferable.

Even in a case where the small particles 12 include the third small particles 12c to the n^{th} small particles 12x in addition to the first small particles 12a and the second small particles 12b, the combination of the coating compositions is not particularly limited, and the third small particles 12c to the n^{th} small particles 12x may include the oxide glass coating having a composition different from compositions of the other small particle groups.

The average thickness of the insulation coating 6 is not particularly limited, and for example, the average thickness is preferably 5 to 100 nm, and more preferably 5 to 50 nm. The first insulation coating 6a to the n^{th} insulation coating 6x may have a similar average thickness or may have average thicknesses different from each other.

Note that, the insulation coating 6 such as the first insulation coating 6a and the second insulation coating 6b may have a stacked structure in which a plurality of coating layers are stacked. For example, the insulation coating 6 may have a stacked structure including an oxide layer of a particle surface, and an oxide glass layer that covers the oxide layer. In a case where one or more kinds of the insulation coatings 6 among the first insulation coating 6a to the n^{th} insulation coating 6x has the stacked structure, a composition of an outermost layer (a coating layer located on the most surface side) may be different among the first insulation coating 6a to the n^{th} insulation coating 6x, and compositions of the other coating layers located between the outermost layer and the particle surface may match each other or may be different from each other among the first insulation coating 6a to the n^{th} insulation coating 6x.

In addition, any of the first small particles 12a to the n^{th} small particles 12x may have the same particle composition or may have particle compositions different from each other. A substance state of the first small particles 12a to the n^{th} small particles 12x is not particularly limited, and one or more kinds of small particle groups among the first small particles 12a to the n^{th} small particles 12x may be amorphous or nanocrystals, but as described above, any of the first small particles 12a to the n^{th} small particles 12x is preferably crystalline.

Total area ratios occupied by the first small particles 12a to the n^{th} small particles 12x on the cross-section of the magnetic core 2a are set as AS₁ to ASₙ. In this case, a total area ratio AS occupied by the small particles 12 on the cross-section of the magnetic core 2a can be expressed as the sum of AS₁ to ASₙ. In addition, ratios of the total area ratios of respective small particle groups to the total area ratio AS of the small particles 12 can be expressed as AS₁/AS to AS₁/AS. Any of AS₁/AS to AS₁/AS is preferably 1% or more, more preferably 6% or more, and still more preferably 10% or more.

When manufacturing the magnetic core 2a, the coating forming treatment is individually formed on each of the small particle groups (first small particles 12a to the n^{th} small particles 12x), and in the coating forming treatment on each of the small particle groups, the powder treatment device 60 as shown in FIG. 4 is preferably used as described in the first embodiment. In addition, the composition of the respective insulation coatings 6 (the first insulation coating 6a, the second insulation coating 6b, and the third insulation coating 6c to the n^{th} insulation coating 6x) may be controlled by a kind or a composition of a coating material that is mixed with a raw material powder. Note that, manufacturing conditions except for the above-described conditions may be set to be similar as in the first embodiment.

### (Summary of Second Embodiment)

In the magnetic core 2a of the second embodiment, the second particle group 10b in which the Heywood diameter is less than 3 μm includes two or more kinds of small particles 12 (the first small particles 12a, the second small particles 12b, and the like) different in a coating composition.

As described above, when the metal magnetic particles 10 include two or more kinds of small particles 12 different in a coating composition, it is considered that when being kneaded with a resin, an electrical repulsive force between the metal magnetic particles is improved, and magnetic aggregation of the metal magnetic particles 10 is suppressed. As a result, in the magnetic core 2a, the DC bias characteristics can be further improved.

Note that, the present invention is not limited to the above-described embodiments, and the above-described embodiments can also be combined, and various modifications can be made within the scope of the present invention.

For example, the structure of the magnetic component is not limited to the aspect shown in FIG. 5, and a magnetic component may be manufactured by combining a plurality of the magnetic cores 2. In addition, the method of manufacturing the magnetic core is not limited to the manufacturing method illustrated in the above-described embodiments, and the magnetic core 2 and the magnetic core 2a may be manufactured by a sheet method or injection molding, or may be manufactured by two-stage compression. In the manufacturing method using the two-stage compression, for example, a plurality of preliminary molded bodies are prepared by temporarily compressing a resin compound, and a magnetic core may be obtained by combining the preliminary molded bodies and by subjecting the resultant combined preliminary molded bodies to main compression.

In addition, the magnetic component is not limited to a magnetic component including the magnetic core, and may be a magnetic component that is not provided with the magnetic core. That is, a composite of a resin and a metal powder may be defined as the magnetic core. For example, a magnetic sheet is exemplified.

### EXAMPLES

Hereinafter, the present invention is described in more detail with reference to specific examples. However, the present disclosure is not limited to the following examples.

### (Experiment 1)

In Experiment 1, amorphous magnetic core samples (Sample Nos. 1 to 6) and nanocrystalline magnetic core samples (Sample Nos. 7 to 12) were manufactured by using metal magnetic particles obtained by mixing one kind of large particles and one kind of small particles. Note that, the magnetic cores of Sample Nos. 1 to 12 shown in Experiment 1 correspond to comparative examples.

As a raw material powder of the metal magnetic particles, a large-diameter powder having the amorphous structure, a large-diameter powder having the nanocrystal structure, and a small-diameter powder composed of small particles of pure ion were prepared. The large-diameter powder having the amorphous structure is an Fe—Co—B—P—Si—Cr-based alloy powder and was manufactured by a rapid-cooling gas atomization method. An average particle size of the Fe—Co—B—P—Si—Cr-based alloy powder was 20 μm, and the degree of amorphization was 85% or more.

The large-diameter powder having the nanocrystal structure is an Fe—Si—B—Nb—Cu-based alloy powder and was manufactured by performing a heat treatment on a powder obtained by the rapid-cooling gas atomization method. An average particle size of the Fe—Si—B—Nb—Cu-based alloy powder was 20 μm, the degree of amorphization was less than 85%, and an average crystallite diameter was within a range of 0.5 to 30 nm. In addition, an average particle size of the pure iron powder that is the small-diameter powder was 1 μm.

In Sample Nos. 1 to 6 in Experiment 1, the coating forming treatment using the mechano-fusion device was performed on the large-diameter powder having the amorphous structure to form an insulation coating of P—Zn—Al—O-based oxide glass on surfaces of large particles. On the other hand, in Sample Nos. 7 to 12 in Experiment 1, the coating forming treatment using the mechano-fusion device was performed on the large-diameter powder having the nanocrystal structure to form an insulation coating of P—Zn—Al—O-based oxide glass on surfaces of large particles. Note that, in the coating forming treatment, an addition amount of the coating material was controlled so that an average thickness of the insulation coating becomes values shown in Table 1.

The coating forming treatment was performed on the small-diameter powder used in Experiment 1 by using the powder treatment device (Nobilta, manufactured by HOSOKAWA MICRON CORPORATION) as shown in FIG. 4 to form an insulation coating of Ba—Zn—B—Si—Al—O-based oxide glass on surfaces of small particles. An average thickness of the insulation coatings formed on the small particles was within a range of 15±10 nm in any sample.

Next, raw material powders (a large-diameter powder and a small-diameter powder) of the metal magnetic particles, and an epoxy resin were kneaded to obtain a resin compound. More specifically, in Sample Nos. 1 to 6, large particles having the amorphous structure and small particles were mixed to obtain a resin compound. On the other hand, in Sample Nos. 7 to 12, large particles having the nanocrystal structure and small particles were mixed to obtain a resin compound. Note that, an addition amount of the epoxy resin (the amount of the resin) in the resin compound was set to 2.5 parts by mass with respect to 100 parts by mass of metal magnetic particles in any sample in Experiment 1. In addition, the large-diameter powder and the small-diameter powder were mixed so that an area ratio satisfies a relationship of “large particles:small particles=approximately 8:2” in any sample in Experiment 1.

Next, the resin compound was filled in a press mold and was pressurized to obtain a green compact having a toroidal shape. A molding pressure at this time was controlled so that magnetic permeability (relative magnetic permeability) of the magnetic core becomes 35. Then, the green compact was subjected to a heating treatment at 180° C. for 60 minutes to harden the epoxy resin inside the green compact, thereby obtaining a magnetic core having a toroidal shape (an external shape of 11 mm, an inner diameter of 6.5 mm, and a thickness of 2.5 mm).

In the respective samples in Experiment 1, the following evaluation was made on the prepared magnetic cores.

### Cross-Section Observation of Magnetic Core

A cross-section of each of the magnetic cores was observed with a SEM to calculate a ratio of a total area of the metal magnetic particles (the total area ratio A0 of the metal magnetic particles) to a total area (1000000 μm²) of an observation field of view. The total area ratio A0 of the metal magnetic particles was within a range of 80±2% in any of the respective samples in Experiment 1.

In addition, at the time of the SEM observation, the Heywood diameter of each of the metal magnetic particles was measured, and area analysis with the EDX was performed to specify a composition system of the metal magnetic particles, and the metal magnetic particles observed on the cross-section of the magnetic core were classified into large particles and small particles. In the respective samples in Experiment 1, D20 of the large particles was 3 μm or more, an average particle size (an arithmetic average value of the Heywood diameter) of the large particles was within a range of 10 to 30 μm, D80 of the small particles was less than 3 μm, and an average particle size of the small particles was within a range of 0.5 to 1.5 μm. In addition, a total area of the large particles included in the observation field of view and a total area of the small particles included in the observation field of view were measured, and a ratio (AL/A0) of the total area of the large particles to the total area of the metal magnetic particles, and a ratio (AS/A0) of the total area of the small particles to the total area of the metal magnetic particles were calculated.

In addition, in the SEM observation, the thickness of the insulation coating of each of the large particles existing in the observation field of view was measured, and an average thickness thereof was calculated.

### Evaluation of Magnetic Permeability and DC Bias Characteristics

In evaluation of the magnetic permeability and the DC bias characteristics, first, a polyurethane copper wire (UEW wire) was wound around the magnetic core having a toroidal shape. Then, an inductance of the magnetic core at a frequency of 20 kHz was measured by using an LCR meter (4284A, manufactured by Agilent Technologies Japan, Ltd.) and a DC bias power supply (42841A, manufactured by Agilent Technologies Japan, Ltd.). More specifically, an inductance under a condition (0 kA/m) in which a DC magnetic field is not applied, and an inductance under a condition in which a DC magnetic field of 8 kA/m is applied were measured, and μ0 (magnetic permeability at 0 A/m) and μHdc (magnetic permeability at 8 kA/m) were calculated from the inductances.

The DC bias characteristics were evaluated on the basis of a variation rate of the magnetic permeability when applying the DC magnetic field. That is, the variation rate (unit: %) of the magnetic permeability is expressed as (μ0−μHdc)/μ0, and as the variation rate of the magnetic permeability is smaller, the DC bias characteristics can be determined as being good.

### Evaluation of Core Loss

A core loss (unit: kW/m³) of each of the magnetic cores was measured by using a BH analyzer (SY-8218, manufactured by IWATSU ELECTRIC CO., LTD.). A magnetic flux density when measuring the core loss was set to 200 mT, and a frequency was set to 20 KHz.

### Overall Evaluation of Experiment 1

Evaluation results of Experiment 1 are shown in Table 1A.

TABLE 1A

| | | | | | | | | Magnetic | | |
|---|---|---|---|---|---|---|---|---|---|---|
| | | Large particles | | | | Area ratio (%) | | permeability | DC bias | Core loss |
| | Example/ | | | Coating | | First large | Small | Measured | characteristics | Measured |
| Sample | Comparative | | Coating | thickness | Small | particles | particles | value | Measured value | value |
| No. | Example | Structure | composition | (nm) | particles | AL/A0 | AS/A0 | (μ0) | (Variation rate) | (kW/m³) |
| 1 | Comparative | Amorphous | P—Zn—Al—O-based | 5 | Fe | 78.7 | 21.3 | 35.0 | 7.5% | 900 |
| | Example | | | | | | | | | |
| 2 | Comparative | Amorphous | P—Zn—Al—O-based | 15 | Fe | 80.8 | 19.2 | 35.3 | 8.3% | 910 |
| | Example | | | | | | | | | |
| 3 | Comparative | Amorphous | P—Zn—Al—O-based | 50 | Fe | 78.7 | 21.3 | 34.7 | 8.4% | 920 |
| | Example | | | | | | | | | |
| 4 | Comparative | Amorphous | P—Zn—Al—O-based | 100 | Fe | 80.8 | 19.2 | 35.4 | 8.5% | 940 |
| | Example | | | | | | | | | |
| 5 | Comparative | Amorphous | P—Zn—Al—O-based | 150 | Fe | 80.2 | 19.8 | 35.2 | 8.6% | 980 |
| | Example | | | | | | | | | |
| 6 | Comparative | Amorphous | P—Zn—Al—O-based | 200 | Fe | 79.9 | 20.1 | 35.3 | 8.7% | 990 |
| | Example | | | | | | | | | |
| 7 | Comparative | Nanocrystal | P—Zn—Al—O-based | 5 | Fe | 79.6 | 20.4 | 35.0 | 22.3% | 350 |
| | Example | | | | | | | | | |
| 8 | Comparative | Nanocrystal | P—Zn—Al—O-based | 15 | Fe | 79.8 | 20.2 | 34.5 | 21.2% | 380 |
| | Example | | | | | | | | | |
| 9 | Comparative | Nanocrystal | P—Zn—Al—O-based | 50 | Fe | 79.7 | 20.3 | 35.4 | 23.2% | 380 |
| | Example | | | | | | | | | |
| 10 | Comparative | Nanocrystal | P—Zn—Al—O-based | 100 | Fe | 80.5 | 19.5 | 34.6 | 21.4% | 390 |
| | Example | | | | | | | | | |
| 11 | Comparative | Nanocrystal | P—Zn—Al—O-based | 150 | Fe | 80.2 | 19.8 | 35.0 | 22.3% | 400 |
| | Example | | | | | | | | | |
| 12 | Comparative | Nanocrystal | P—Zn—Al—O-based | 200 | Fe | 80.1 | 19.9 | 35.0 | 22.3% | 420 |
| | Example | | | | | | | | | |

As shown in Table 1A, in the magnetic cores (amorphous magnetic cores) of Sample Nos. 1 to 6 in which the large particles having the amorphous structure are set as a main powder, the DC bias characteristics were better but the core loss tended to be higher in comparison to the magnetic cores (nanocrystalline magnetic cores) of Sample Nos. 7 to 12 in which the large particles having the nanocrystal structure are set as a main powder. On the contrary, in the nanocrystalline magnetic cores of Sample Nos. 7 to 12, the core loss was lower but the DC bias characteristics tended to be inferior in comparison to the amorphous magnetic cores.

Note that, it could be understood that in both the nanocrystalline magnetic cores and the amorphous magnetic cores, when the insulation coating provided in the large particles is made to be thicker, the core loss tends to increase. From the results, it could be understood that it is not easy to make a low core loss and good DC bias characteristics be compatible with each other in a case where the main powder of the magnetic cores is composed of only one kind of large particles.

### (Experiment 2)

In Experiment 2, as shown in Table 1B and Table 1C, magnetic cores were manufactured by using metal magnetic particles obtained by mixing first large particles having the amorphous structure and second large particles having the nanocrystal structure.

Even in Experiment 2, as a raw material powder of the metal magnetic particles, an Fe—Co—B—P—Si—Cr-based alloy powder (first large particles having the amorphous structure) and an Fe—Si—B—Nb—Cu-based alloy powder (second large particles having the nanocrystalline structure) which have the same specification as in Experiment 1, and a pure iron powder (small particles) were prepared.

Next, an insulation coating of P—Zn—Al—O-based oxide glass was formed on surfaces of the particles of the Fe—Co—B—P—Si—Cr-based alloy powder by using a mechano-fusion device. At this time, the thickness of the insulation coating was adjusted by controlling an addition amount of a coating material and treatment time, thereby obtaining six kinds of first large particles different in the average thickness T1. Similarly, the coating forming treatment using the mechano-fusion device was performed on the Fe—Si—B—Nb—Cu-based alloy powder (an insulation coating of P—Zn—Al—O-based oxide glass was formed), thereby obtaining six kinds of second large particles different in the average thickness T2. In addition, the coating forming treatment was performed on the pure iron powder by using the powder treatment device as shown in FIG. 4 to form an insulation coating of Ba—Zn—B—Si—Al—O-based oxide glass on surfaces of the small particles. An average thickness of the insulation coating of the small particles was within a range of 15±10 nm.

Next, the first large particles having the amorphous structure, the second large particles having the nanocrystal structure, the small particles, and an epoxy resin were kneaded to obtain a resin compound. At this time, the large particles and the small particles were mixed so that an area ratio satisfies a relationship of “first large particles:second large particles:small particles=4:4:2” in any sample in Experiment 2. In addition, an addition amount of the epoxy resin (the amount of the resin) in the resin compound was set to 2.5 parts by mass with respect to 100 parts by mass of metal magnetic particles in any sample in Experiment 2.

Next, the resin compound was filled in a press mold and was pressurized to obtain a green compact having a toroidal shape. A molding pressure at this time was controlled so that magnetic permeability (μ0) of the magnetic core becomes 35. Then, the green compact was subjected to a heating treatment at 180° C. for 60 minutes to harden the epoxy resin inside the green compact, thereby obtaining a magnetic core having a toroidal shape (an external shape of 11 mm, an inner diameter of 6.5 mm, and a thickness of 2.5 mm).

Even in Experiment 2, similar evaluation (cross-section observation of the magnetic cores, and measurement of the magnetic permeability, the DC bias characteristics, and the core loss) as in Experiment 1 was performed. In cross-section observation of the magnetic core, in any sample, it was confirmed that D20 of the first large particles and the second large particles was 3 μm or more, an average particle size of the first large particles and the second large particles was within a range of 10 to 30 μm, D80 of the small particles was less than 3 μm, and an average particle size of the small particles was within a range of 0.5 to 1.5 μm.

In addition, an average thickness T1 of the insulation coating provided in the first large particles having the amorphous structure, an average thickness T2 of the insulation coating provided in the second large particles having the nanocrystal structure, and ratios (AL₁/A0, AL₂/A0, AS/A0) of total areas of respective particle groups to a total area of the metal magnetic particles become results shown in Table 1B and Table 1C. Note that, the total area ratio A0 of the metal magnetic particles was within a range of 80±2% in any of the samples in Experiment 2.

In Experiment 2, an expected value of the core loss (a calculated value of the core loss which is calculated from the mixing ratio) was calculated on the basis of the mixing ratio of the first large particles and the second large particles, and the improvement rate of the core loss in each sample was obtained with the expected value set as a reference. For example, the expected value of the core loss in Sample No. 13 was calculated by the following expression.

Expected value=[(β₁/α₁)×C₁]+[(β₂/α₇)×C₇]

α₁: Ratio (AL/A0) of amorphous large particles in Sample No. 1

C₁: Core loss of Sample No. 1
α₇: Ratio (AL/A0) of nanocrystalline large particles in Sample No. 7

C₇: Core loss of Sample No. 7

β₁: Ratio (AL₁/A0) of amorphous large particles in Sample No. 13

β₂: Ratio (AL₂/A0) of nanocrystalline large particles in Sample No. 13

As described above, when calculating the expected value (calculated value), characteristic values of the magnetic cores (Sample Nos. 1 to 12) containing large particles having the same specifications (a particle composition, a coating composition, and an average thickness) as in the large particles used in the respective samples (Sample Nos. 13 to 48) were used with reference to Table 1A.

After calculating the expected value of the core loss by the above-described method, an improvement rate [(expected value−measured value)/expected value] between the expected value and an actually measured core loss was calculated. As the “improvement rate” is larger, the core loss is further reduced. In this experiment, when the improvement rate was 5% or more, preferably 10% or more, and more preferably 15% or more, determination was made as good. Results are shown in Table 1B and Table 1C.

In addition, with regard to the DC bias characteristics, in addition to a measured value, an improvement rate from an expected value (calculated value) was obtained by calculation as in the core loss. Results are shown in Table 1B and Table 1C. With regard to the DC bias characteristics, samples in which the improvement rate was −1% or more were determined as being equivalent to the cores shown in Table 1A or good.

TABLE 1B

| | | | Nanocrystalline | | | | |
|---|---|---|---|---|---|---|---|
| | | Amorphous first | second large | | Area ratio (%) | | |
| | Example/ | large particles | particles | | First large | Second large | Small |
| Sample | Comparative | Coating thickness | Coating thickness | | particles | particles | particles |
| No. | Example | T1 (nm) | T2 (nm) | T1/T2 | AL₁/A0 | AL₂/A0 | AS/A0 |
| 13 | Comparative | 5 | 5 | 1.0 | 40.8 | 40.6 | 18.6 |
| | Example | | | | | | |
| 14 | Comparative | 5 | 15 | 0.3 | 40.4 | 40.7 | 18.9 |
| | Example | | | | | | |
| 15 | Comparative | 5 | 50 | 0.1 | 40.3 | 40.0 | 19.7 |
| | Example | | | | | | |
| 16 | Comparative | 5 | 100 | 0.1 | 41.4 | 39.9 | 18.7 |
| | Example | | | | | | |
| 17 | Comparative | 5 | 150 | 0.0 | 39.3 | 39.3 | 21.4 |
| | Example | | | | | | |
| 18 | Comparative | 5 | 200 | 0.0 | 41.3 | 39.1 | 19.6 |
| | Example | | | | | | |
| 19 | Example | 15 | 5 | 3.0 | 40.3 | 39.7 | 20.0 |
| 20 | Comparative | 15 | 15 | 1.0 | 40.4 | 40.7 | 18.9 |
| | Example | | | | | | |
| 21 | Comparative | 15 | 50 | 0.3 | 40.6 | 40.5 | 18.9 |
| | Example | | | | | | |
| 22 | Comparative | 15 | 100 | 0.2 | 41.0 | 40.9 | 18.1 |
| | Example | | | | | | |
| 23 | Comparative | 15 | 150 | 0.1 | 39.3 | 41.0 | 19.7 |
| | Example | | | | | | |
| 24 | Comparative | 15 | 200 | 0.1 | 40.2 | 38.9 | 20.9 |
| | Example | | | | | | |
| 25 | Example | 50 | 5 | 10.0 | 38.6 | 39.0 | 22.4 |
| 26 | Example | 50 | 15 | 3.3 | 40.9 | 40.9 | 18.2 |
| 27 | Comparative | 50 | 50 | 1.0 | 39.3 | 41.4 | 19.3 |
| | Example | | | | | | |
| 28 | Comparative | 50 | 100 | 0.5 | 41.0 | 40.9 | 18.1 |
| | Example | | | | | | |
| 29 | Comparative | 50 | 150 | 0.3 | 40.7 | 39.7 | 19.6 |
| | Example | | | | | | |
| 30 | Comparative | 50 | 200 | 0.3 | 38.8 | 41.5 | 19.7 |
| | Example | | | | | | |

| | Magnetic | | | | | | |
|---|---|---|---|---|---|---|---|
| | permeability | | | | Core loss | | |
| | Measured | DC bias characteristics | | | Measured | | |
| Sample | value | Measured value | Calculated | Improvement | value | Calculated | Improvement |
| No. | (μ0) | (Variation rate) | value | rate | (kW/m³) | value | rate |
| 13 | 34.9 | 14.4% | 15.3% | 0.9% | 630 | 645 | 2.4% |
| 14 | 35.3 | 13.6% | 14.7% | 1.1% | 660 | 656 | −0.6% |
| 15 | 34.6 | 13.6% | 15.5% | 1.9% | 680 | 652 | −4.3% |
| 16 | 35.2 | 13.3% | 14.6% | 1.3% | 640 | 667 | 4.0% |
| 17 | 35.1 | 13.3% | 14.7% | 1.4% | 630 | 646 | 2.4% |
| 18 | 34.6 | 13.5% | 14.8% | 1.3% | 660 | 677 | 2.6% |
| 19 | 35.4 | 14.9% | 15.3% | 0.4% | 500 | 628 | 20.4% |
| 20 | 35.4 | 14.8% | 14.9% | 0.1% | 650 | 649 | −0.2% |
| 21 | 34.9 | 14.8% | 15.9% | 1.1% | 660 | 650 | −1.5% |
| 22 | 34.5 | 14.0% | 15.1% | 1.1% | 690 | 660 | −4.6% |
| 23 | 35.3 | 13.8% | 15.4% | 1.6% | 700 | 647 | −8.2% |
| 24 | 34.6 | 14.5% | 15.0% | 0.5% | 790 | 657 | −20.3% |
| 25 | 35.1 | 15.2% | 15.0% | −0.2% | 500 | 623 | 19.7% |
| 26 | 35.3 | 14.8% | 15.2% | 0.4% | 520 | 673 | 22.7% |
| 27 | 35.2 | 14.3% | 16.2% | 1.9% | 650 | 657 | 1.1% |
| 28 | 35.1 | 13.8% | 15.2% | 1.4% | 700 | 678 | −3.3% |
| 29 | 34.5 | 13.5% | 15.4% | 1.9% | 720 | 674 | −6.8% |
| 30 | 34.6 | 14.4% | 15.7% | 1.3% | 780 | 671 | −16.2% |

TABLE 1C

| | | | Nanocrystalline | | | | |
|---|---|---|---|---|---|---|---|
| | | Amorphous first | second large | | Area ratio (%) | | |
| | Example/ | large particles | particles | | First large | Second large | Small |
| Sample | Comparative | Coating thickness | Coating thickness | | particles | particles | particles |
| No. | Example | T1 (nm) | T2 (nm) | T1/T2 | AL₁/A0 | AL₂/A0 | AS/A0 |
| 31 | Example | 100 | 5 | 20.0 | 39.6 | 41.3 | 19.1 |
| 32 | Example | 100 | 15 | 6.7 | 40.3 | 39.1 | 20.6 |
| 33 | Example | 100 | 50 | 2.0 | 38.6 | 40.8 | 20.6 |
| 34 | Comparative | 100 | 100 | 1.0 | 39.9 | 39.5 | 20.6 |
| | Example | | | | | | |
| 35 | Comparative | 100 | 150 | 0.7 | 39.2 | 39.6 | 21.2 |
| | Example | | | | | | |
| 36 | Comparative | 100 | 200 | 0.5 | 38.7 | 39.3 | 22.0 |
| | Example | | | | | | |
| 37 | Example | 150 | 5 | 30.0 | 38.8 | 40.2 | 21.0 |
| 38 | Example | 150 | 15 | 10.0 | 41.1 | 41.2 | 17.7 |
| 39 | Example | 150 | 50 | 3.0 | 38.8 | 39.3 | 21.9 |
| 40 | Example | 150 | 100 | 1.5 | 40.9 | 38.7 | 20.4 |
| 41 | Comparative | 150 | 150 | 1.0 | 39.6 | 41.4 | 19.0 |
| | Example | | | | | | |
| 42 | Comparative | 150 | 200 | 0.8 | 41.3 | 40.2 | 18.5 |
| | Example | | | | | | |
| 43 | Example | 200 | 5 | 40.0 | 39.4 | 40.7 | 19.9 |
| 44 | Example | 200 | 15 | 13.3 | 39.7 | 40.0 | 20.3 |
| 45 | Example | 200 | 50 | 4.0 | 41.0 | 39.2 | 19.8 |
| 46 | Example | 200 | 100 | 2.0 | 39.6 | 40.7 | 19.7 |
| 47 | Example | 200 | 150 | 1.3 | 40.7 | 39.5 | 19.8 |
| 48 | Comparative | 200 | 200 | 1.0 | 39.5 | 40.3 | 20.2 |
| | Example | | | | | | |

| | Magnetic | DC bias characteristics | | | | | |
|---|---|---|---|---|---|---|---|
| | permeability | Measured | | | Core loss | | |
| | Measured | value | | | Measured | | |
| Sample | value | (Variation | Calculated | Improvement | value | Calculated | Improvement |
| No. | (m0) | rate) | value | rate | (kW/m³) | value | rate |
| 31 | 35.2 | 15.3% | 15.7% | 0.4% | 510 | 643 | 20.6% |
| 32 | 34.6 | 14.7% | 14.6% | −0.1% | 520 | 655 | 20.6% |
| 33 | 34.8 | 16.1% | 15.9% | −0.2% | 530 | 644 | 17.7% |
| 34 | 34.9 | 13.8% | 14.7% | 0.9% | 660 | 656 | −0.6% |
| 35 | 34.8 | 14.0% | 15.1% | 1.1% | 680 | 654 | −4.0% |
| 36 | 34.6 | 14.2% | 15.0% | 0.8% | 800 | 657 | −21.8% |
| 37 | 34.6 | 15.0% | 15.3% | 0.3% | 490 | 651 | 24.7% |
| 38 | 35.0 | 14.9% | 15.3% | 0.4% | 520 | 698 | 25.5% |
| 39 | 35.0 | 16.2% | 15.5% | −0.7% | 560 | 662 | 15.4% |
| 40 | 35.4 | 14.3% | 14.6% | 0.3% | 580 | 687 | 15.6% |
| 41 | 35.1 | 14.4% | 15.7% | 1.3% | 700 | 690 | −1.4% |
| 42 | 34.5 | 14.2% | 15.5% | 1.3% | 780 | 715 | −9.0% |
| 43 | 35.2 | 15.0% | 15.7% | 0.7% | 490 | 667 | 26.6% |
| 44 | 34.9 | 14.8% | 14.9% | 0.1% | 540 | 682 | 20.9% |
| 45 | 35.3 | 16.1% | 15.9% | −0.2% | 570 | 695 | 18.0% |
| 46 | 35.4 | 14.8% | 15.1% | 0.3% | 580 | 688 | 15.7% |
| 47 | 35.5 | 15.4% | 15.4% | 0.0% | 590 | 701 | 15.9% |
| 48 | 35.3 | 15.5% | 15.5% | 0.0% | 700 | 701 | 0.1% |

As shown in Table 1B and Table 1C, in the respective samples in Experiment 2, the core loss could be further lowered in comparison to the amorphous magnetic cores (Sample Nos. 1 to 6). In addition, in comparative examples in which T1/T2 is 1.0 or less, the core loss was equivalent to the expected value calculated from the mixing ratio, or was worse than the expected value. On the contrary, in examples in which T1/T2 is more than 1.0, the core loss was lowered from the expected value (calculated value) by 15% or more. Note that, with regard to the DC bias characteristics, in the examples (T1/T2 is more than 1.0) and the comparative examples (T1/T2 is 1.0 or less), no significant difference was recognized in the improvement rate, and the DC bias characteristics were further improved in comparison to the nanocrystalline magnetic cores (Sample Nos. 7 to 12) in any of the examples and the comparative examples.

As described above, when mixing the first large particles which include the relatively thick insulation coating and have the amorphous structure, and the second large particles which include the relatively thin insulation coating and have the nanocrystal structure, it could be confirmed that the core loss could be reduced while maintaining good DC bias characteristics. Particularly, in magnetic cores (examples) satisfying a relationship of T1>T2, it could be confirmed that T1/T2 is preferably 1.3 or more from the viewpoint of reducing the core loss, more preferably 1.5 or more, and still more preferably 2.0 or more. Note that, T2 is preferably 5 nm or more from the viewpoint of reducing the core loss while securing insulation. It could be confirmed that an upper limit of T2 is determined on the basis of T1, and may be, for example, 150 nm or less, 100 nm or less, or 50 nm or less.

### (Experiment 3)

In Experiment 3, magnetic cores (Sample Nos. 49 to 56) shown in Table 2 were manufactured by changing the composition of the insulation coating provided in the first large particles and the second large particles. Manufacturing conditions other than the composition of the insulation coating were set to be similar as in manufacturing conditions as in Sample No. 32 in Experiment 2, and similar evaluation as in Experiment 1 was made on the respective samples in Experiment 3.

Cross-section observation results, and measurement results of the magnetic permeability, the DC bias characteristics ((μ0−μHdc)/μ0), and the core loss in Experiment 3 are shown in Table 2.

TABLE 2

| | | Amorphous first large particles | | Nanocrystalline second large particles | | |
|---|---|---|---|---|---|---|
| | Example/ | | Coating | | Coating | |
| | Comparative | | thickness | | thickness | Small |
| Sample No. | Example | Coating composition | T1 (nm) | Coating composition | T2 (nm) | particles |
| 32 | Example | P—Zn—Al—O-based | 100 | P—Zn—Al—O-based | 15 | Fe |
| 49 | Example | Bi—Zn—B—Si—O-based | 100 | P—Zn—Al—O-based | 15 | Fe |
| 50 | Example | Ba—Zn—B—Si—Al—O-based | 100 | P—Zn—Al—O-based | 15 | Fe |
| 51 | Example | P—Zn—Al—O-based | 100 | Bi—Zn—B—Si—O-based | 15 | Fe |
| 52 | Example | Bi—Zn—B—Si—O-based | 100 | Bi—Zn—B—Si—O-based | 15 | Fe |
| 53 | Example | Ba—Zn—B—Si—Al—O-based | 100 | Bi—Zn—B—Si—O-based | 15 | Fe |
| 54 | Example | P—Zn—Al—O-based | 100 | Ba—Zn—B—Si—Al—O-based | 15 | Fe |
| 55 | Example | Bi—Zn—B—Si—O-based | 100 | Ba—Zn—B—Si—Al—O-based | 15 | Fe |
| 56 | Example | Ba—Zn—B—Si—Al—O-based | 100 | Ba—Zn—B—Si—Al—O-based | 15 | Fe |

| | | | | Magnetic | | |
|---|---|---|---|---|---|---|
| | Area ratio (%) | | | permeability | DC bias | Core loss |
| | First large | Second large | Small | Measured | characteristics | Measured |
| | particles | particles | particles | value | Measured value | value |
| Sample No. | AL₁/A0 | AL₂/A0 | AS/A0 | (μ0) | (Variation rate) | (kW/m³) |
| 32 | 40.3 | 39.1 | 20.6 | 34.6 | 14.7% | 520 |
| 49 | 40.8 | 40.8 | 18.4 | 35.1 | 14.0% | 520 |
| 50 | 40.9 | 40.9 | 18.2 | 34.7 | 14.1% | 510 |
| 51 | 40.1 | 40.1 | 19.8 | 35.1 | 13.9% | 530 |
| 52 | 40.3 | 40.3 | 19.4 | 34.8 | 14.4% | 520 |
| 53 | 40.7 | 40.7 | 18.6 | 35.3 | 13.8% | 510 |
| 54 | 39.8 | 39.8 | 20.4 | 34.9 | 14.1% | 520 |
| 55 | 40.4 | 40.4 | 19.2 | 34.7 | 14.1% | 530 |
| 56 | 41.1 | 41.1 | 17.8 | 34.6 | 14.5% | 530 |

In the respective samples in Experiment 3, the DC bias characteristics and the core loss were similar as in Sample No. 32 in Experiment 2, and the core loss could be reduced while maintaining good DC bias characteristics. It could be confirmed that the composition of the insulation coating formed on each of the large particles may be changed as in Table 2.

### (Experiment 4)

In Example 4, magnetic core samples (Sample Nos. 57 to 74) shown in Table 3 were manufactured by changing the ratio (AL₁/A0) of the first large particles having the amorphous structure, and the ratio (AL₂/A0) of the second large particles having the nanocrystal structure.

In Sample Nos. 57 to 62 as comparative examples, T1 was set to 15 nm, T2 was set to 100 nm, and manufacturing conditions other than the ratios of the large particles were set to be similar as in Sample No. 22 in Experiment 2. In Sample Nos. 63 to 68, T1 and T2 were set to 15 nm, and manufacturing conditions other than the ratios of the large particles were set to be similar as in Sample No. 20 in Experiment 2. In Sample Nos. 69 to 74, T1 was set to 100 nm, T2 was set to 15 nm, and manufacturing conditions other than the ratios of the large particles were set to be similar as in Sample No. 32 in Experiment 2.

In Experiment 4, similar evaluation as in Experiment 2 was made. Evaluation results are shown in Table 3.

TABLE 3

| | | Amorphous | Nanocrystalline | | | |
|---|---|---|---|---|---|---|
| | | first large | second large | | | |
| | | particles | particles | | Area ratio (%) | |
| | | Coating | Coating | | First large | Second large |
| Sample | Example/ | thickness | thickness | Small | particles | particles |
| No. | Comparative Example | T1 (nm) | T2 (nm) | particles | AL₁/A0 | AL₂/A0 |
| 2 | Comparative Example | 15 | — | Fe | 80.8 | — |
| 57 | Comparative Example | 15 | 100 | Fe | 76.0 | 3.7 |
| 58 | Comparative Example | 15 | 100 | Fe | 71.5 | 7.1 |
| 59 | Comparative Example | 15 | 100 | Fe | 64.2 | 16.4 |
| 22 | Comparative Example | 15 | 100 | Fe | 41.0 | 40.9 |
| 60 | Comparative Example | 15 | 100 | Fe | 15.5 | 64.3 |
| 61 | Comparative Example | 15 | 100 | Fe | 8.6 | 72.3 |
| 62 | Comparative Example | 15 | 100 | Fe | 3.6 | 76.7 |
| 10 | Comparative Example | — | 100 | Fe | — | 80.5 |
| 2 | Comparative Example | 15 | — | Fe | 80.8 | — |
| 63 | Comparative Example | 15 | 15 | Fe | 76.3 | 3.6 |
| 64 | Comparative Example | 15 | 15 | Fe | 72.0 | 7.9 |
| 65 | Comparative Example | 15 | 15 | Fe | 64.3 | 16.1 |
| 20 | Comparative Example | 15 | 15 | Fe | 40.4 | 40.7 |
| 66 | Comparative Example | 15 | 15 | Fe | 16.1 | 64.1 |
| 67 | Comparative Example | 15 | 15 | Fe | 8.3 | 72.7 |
| 68 | Comparative Example | 15 | 15 | Fe | 4.0 | 76.6 |
| 8 | Comparative Example | — | 15 | Fe | — | 79.8 |
| 4 | Comparative Example | 100 | — | Fe | 80.8 | — |
| 69 | Example | 100 | 15 | Fe | 75.7 | 4.5 |
| 70 | Example | 100 | 15 | Fe | 71.3 | 7.7 |
| 71 | Example | 100 | 15 | Fe | 64.5 | 16.3 |
| 32 | Example | 100 | 15 | Fe | 40.3 | 39.1 |
| 72 | Example | 100 | 15 | Fe | 15.3 | 64.2 |
| 73 | Example | 100 | 15 | Fe | 8.3 | 72.6 |
| 74 | Example | 100 | 15 | Fe | 5.1 | 76.6 |
| 8 | Comparative Example | — | 15 | Fe | — | 79.8 |

| | | Magnetic | DC bias characteristics | | | |
|---|---|---|---|---|---|---|
| | Area ratio (%) | permeability | Measured | | Core loss | |
| | Small | Measured | value | | Measured | |
| Sample | particles | value | (Variation | Improvement | value | Improvement |
| No. | AS/A0 | (μ0) | rate) | rate | (kW/m³) | rate |
| 2 | 19.2 | 35.3 | 8.3% | — | 910 | — |
| 57 | 20.3 | 35.2 | 7.7% | 1.1% | 870 | 0.4% |
| 58 | 21.4 | 34.9 | 8.1% | 1.1% | 840 | −0.1% |
| 59 | 19.4 | 35.2 | 9.7% | 1.2% | 820 | −2.2% |
| 22 | 18.1 | 34.5 | 14.0% | 1.1% | 690 | 4.6% |
| 60 | 20.2 | 35.4 | 17.2% | 1.5% | 520 | −7.0% |
| 61 | 19.1 | 35.3 | 18.8% | 1.3% | 480 | −7.4% |
| 62 | 19.7 | 34.7 | 18.6% | 2.1% | 450 | −9.2% |
| 10 | 19.5 | 34.6 | 21.4% | — | 390 | — |
| 2 | 19.2 | 35.3 | 8.3% | — | 910 | — |
| 63 | 20.1 | 35.1 | 8.8% | 0.0% | 870 | 0.7% |
| 64 | 20.1 | 34.9 | 9.5% | 0.0% | 850 | −0.2% |
| 65 | 19.6 | 34.6 | 10.8% | 0.1% | 800 | 0.1% |
| 20 | 18.9 | 35.4 | 14.8% | 0.1% | 640 | 1.3% |
| 66 | 19.8 | 34.8 | 18.4% | 0.3% | 480 | 1.4% |
| 67 | 19.0 | 34.9 | 20.2% | −0.1% | 450 | −2.3% |
| 68 | 19.4 | 35.4 | 20.5% | 0.2% | 420 | −2.5% |
| 8 | 20.2 | 34.5 | 21.2% | — | 380 | — |
| 4 | 19.2 | 35.4 | 8.5% | — | 940 | — |
| 69 | 19.8 | 34.7 | 9.1% | 0.1% | 800 | 11.4% |
| 70 | 21.0 | 35.5 | 9.4% | 0.1% | 760 | 12.3% |
| 71 | 19.2 | 35.3 | 11.0% | 0.1% | 700 | 15.5% |
| 32 | 20.6 | 34.6 | 14.7% | −0.1% | 520 | 20.6% |
| 72 | 20.5 | 35.1 | 18.2% | 0.4% | 410 | 15.3% |
| 73 | 19.1 | 35.0 | 20.1% | 0.0% | 390 | 11.8% |
| 74 | 18.3 | 35.3 | 20.7% | 0.2% | 390 | 8.1% |
| 8 | 20.2 | 34.5 | 21.2% | — | 380 | — |

As shown in Table 3, in examples satisfying a relationship of T1>T2, even when changing the mixing ratio of the first large particles and the second large particles, the core loss could be reduced by 5% or more even in amorphous magnetic cores. Particularly, it could be confirmed that any of AL₁/A0 and AL₂/A0 is preferably 3% or more, more preferably 4% to 78%, and still more preferably 7% to 44%.

In addition, from results shown in Table 3, it could be confirmed that each of AL₁/(AL₁+AL₂) and AL₂/(AL₁+AL₂) may be set within a range of 4% to 96%, AL₁/(AL₁+AL₂) is more preferably 50% to 96% from the viewpoint of obtaining excellent DC bias characteristics, and AL₂/(AL₁+AL₂) is more preferably 50% to 90% from the viewpoint of further lowering the core loss.

Furthermore, it could also be confirmed that from the viewpoints of improving the core loss and the DC bias characteristics with balance and of enhancing the effect of improving the core loss, AL₁/(AL₁+AL₂) is preferably 10% to 94%, and more preferably 18% to 85%.

### (Experiment 5)

In Experiment 5, magnetic core samples (Sample Nos. 75 to 92) shown in Table 4 were manufactured by changing the ratio (AS/A0) of the small particles. In the respective samples in Experiment 5, large particles having the amorphous structure and large particles having the nanocrystal structure were mixed in a ratio of approximately “1:1”. Manufacturing conditions other than the ratio of the small particles were set to be similar as in Experiment 2 except that the molding pressure was changed in conformity to a mixing ratio of the small particles, and the magnetic permeability, the DC bias characteristics ((μ0−μHdc)/μ0), and the core loss were measured. Evaluation results are shown in Table 4.

TABLE 4

| | | Amorphous | Nanocrystalline | | | | | | | |
|---|---|---|---|---|---|---|---|---|---|---|
| | | first large | second large | | | | | Magnetic | | |
| | | particles | particles | | Area ratio (%) | | | permeability | DC bias | Core loss |
| | Example/ | Coating | Coating | | First large | Second large | Small | Measured | characteristics | Measured |
| Sample | Comparative | thickness | thickness | Small | particles | particles | particles | value | Measured value | value |
| No. | Example | T1 (nm) | T2 (nm) | particles | AL₁/A0 | AL₂/A0 | AS/A0 | (μ0) | (Variation rate) | (kW/m³) |
| 75 | Comparative | 15 | 100 | — | 48.7 | 51.3 | 0 | 25.2 | 14.8% | 890 |
| | Example | | | | | | | | | |
| 76 | Comparative | 15 | 15 | — | 49.9 | 50.1 | 0 | 25.4 | 17.3% | 880 |
| | Example | | | | | | | | | |
| 77 | Example | 100 | 15 | — | 50.5 | 49.5 | 0 | 25.3 | 17.6% | 630 |
| 78 | Comparative | 15 | 100 | Fe | 47.5 | 47.7 | 4.8 | 30.3 | 14.4% | 850 |
| | Example | | | | | | | | | |
| 79 | Comparative | 15 | 15 | Fe | 47.3 | 47.8 | 4.9 | 30.1 | 16.1% | 840 |
| | Example | | | | | | | | | |
| 80 | Example | 100 | 15 | Fe | 47.6 | 47.4 | 5.0 | 30.2 | 16.3% | 610 |
| 81 | Comparative | 15 | 100 | Fe | 45.9 | 45.9 | 8.2 | 34.3 | 15.2% | 830 |
| | Example | | | | | | | | | |
| 82 | Comparative | 15 | 15 | Fe | 45.4 | 45.4 | 9.2 | 34.2 | 16.3% | 820 |
| | Example | | | | | | | | | |
| 83 | Example | 100 | 15 | Fe | 43.8 | 43.8 | 12.4 | 34.1 | 16.4% | 600 |
| 22 | Comparative | 15 | 100 | Fe | 41.0 | 40.9 | 18.1 | 34.5 | 14.0% | 690 |
| | Example | | | | | | | | | |
| 20 | Comparative | 15 | 15 | Fe | 40.4 | 40.7 | 18.9 | 35.4 | 14.8% | 650 |
| | Example | | | | | | | | | |
| 32 | Example | 100 | 15 | Fe | 40.3 | 39.1 | 20.6 | 34.6 | 14.7% | 520 |
| 84 | Comparative | 15 | 100 | Fe | 27.5 | 27.5 | 45.0 | 30.3 | 12.2% | 540 |
| | Example | | | | | | | | | |
| 85 | Comparative | 15 | 15 | Fe | 28.1 | 28.1 | 43.8 | 30.4 | 13.1% | 520 |
| | Example | | | | | | | | | |
| 86 | Example | 100 | 15 | Fe | 30.8 | 30.8 | 38.4 | 30.1 | 13.2% | 410 |
| 87 | Comparative | 15 | 100 | Fe | 20.0 | 20.0 | 60.0 | 25.2 | 10.2% | 480 |
| | Example | | | | | | | | | |
| 88 | Comparative | 15 | 15 | Fe | 19.8 | 19.8 | 60.4 | 25.3 | 11.1% | 470 |
| | Example | | | | | | | | | |
| 89 | Example | 100 | 15 | Fe | 16.8 | 16.8 | 66.4 | 25.4 | 11.4% | 350 |
| 90 | Comparative | 15 | 100 | Fe | 11.5 | 11.5 | 77.0 | 20.1 | 9.2% | 450 |
| | Example | | | | | | | | | |
| 91 | Comparative | 15 | 15 | Fe | 10.1 | 10.1 | 79.8 | 20.3 | 10.2% | 480 |
| | Example | | | | | | | | | |
| 92 | Example | 100 | 15 | Fe | 9.2 | 9.2 | 81.6 | 20.4 | 10.3% | 320 |

As shown in Table 4, even in a case of changing the ratio of the small particles, in examples in which T1/T2 is more than 1.0, the core loss was further lowered by 20% or more in comparison to comparative examples in which T1/T2 is 1.0 or less.

Note that, when increasing the ratio of the small particles in the magnetic cores, it could be confirmed that the core loss and the DC bias characteristics tends to be further improved, and the magnetic permeability tends to be decreased. From the viewpoint of improving the core loss and the DC bias characteristics while securing high magnetic permeability, it could be confirmed that the ratio (AS/A0) of the small particles is preferably 5% to 85%, and more preferably 5% or more and less than 50%, 5% to 40%, and 10% to 40% in this order.

### (Experiment 6)

In Experiment 6, magnetic core samples shown in Table 5 were manufactured by changing the packing rate (that is, A0) of the metal magnetic particles. The packing rate of the metal magnetic particles was controlled on the basis of an addition amount of an epoxy resin. The amount of the resin (the content of the epoxy resin with respect to the metal magnetic particles), and the total area ratio A0 of the metal magnetic particles in respective samples in Experiment 6 are shown in Table 5.

Experiment conditions other than the above-described conditions were set to be similar as in Experiment 2, and the magnetic permeability, the DC bias characteristics, and the core loss of the respective samples were evaluated. Results are shown in Table 5.

TABLE 5

| | | | Nanocrystalline | | | |
|---|---|---|---|---|---|---|
| | | Amorphous first | second large | | | |
| | | large particles | particles | | | Area ratio (%) |
| | Example/ | Coating | Coating | | | First large |
| Sample | Comparative | thickness | thickness | Small | A0 | particles |
| No. | Example | T1 (nm) | T2 (nm) | particles | (%) | AL₁/A0 |
| 93 | Comparative | 15 | 100 | Fe | 89.6 | 39.1 |
| | Example | | | | | |
| 94 | Comparative | 15 | 15 | Fe | 89.4 | 40.8 |
| | Example | | | | | |
| 95 | Example | 100 | 15 | Fe | 89.9 | 39.8 |
| 96 | Comparative | 15 | 100 | Fe | 88.0 | 40.1 |
| | Example | | | | | |
| 97 | Comparative | 15 | 15 | Fe | 87.9 | 40.3 |
| | Example | | | | | |
| 98 | Example | 100 | 15 | Fe | 87.8 | 40.3 |
| 22 | Comparative | 15 | 100 | Fe | 79.3 | 41.0 |
| | Example | | | | | |
| 20 | Comparative | 15 | 15 | Fe | 79.6 | 40.4 |
| | Example | | | | | |
| 32 | Example | 100 | 15 | Fe | 79.0 | 40.3 |
| 99 | Comparative | 15 | 100 | Fe | 74.7 | 40.1 |
| | Example | | | | | |
| 100 | Comparative | 15 | 15 | Fe | 75.3 | 40.2 |
| | Example | | | | | |
| 101 | Example | 100 | 15 | Fe | 75.3 | 40.5 |
| 102 | Comparative | 15 | 100 | Fe | 71.1 | 40.8 |
| | Example | | | | | |
| 103 | Comparative | 15 | 15 | Fe | 70.8 | 38.9 |
| | Example | | | | | |
| 104 | Comparative | 100 | 15 | Fe | 70.1 | 41.0 |
| | Example | | | | | |

| | | | | Magnetic | | |
|---|---|---|---|---|---|---|
| | Area ratio (%) | | | permeability | DC bias | Core loss |
| | Second large | Small | Amount of | Measured | characteristics | Measured |
| Sample | particles | particles | resin | value | Measured value | value |
| No. | AL₂/A0 | AS/A0 | wt % | (μ0) | (Variation rate) | (kW/m³) |
| 93 | 41.0 | 19.9 | 1.0 | 44.0 | 29.0% | 890 |
| 94 | 41.0 | 18.2 | 1.0 | 43.4 | 30.3% | 900 |
| 95 | 40.0 | 20.2 | 1.0 | 44.6 | 30.2% | 700 |
| 96 | 40.3 | 19.6 | 1.2 | 40.5 | 24.3% | 880 |
| 97 | 40.5 | 19.2 | 1.2 | 40.6 | 24.9% | 870 |
| 98 | 40.4 | 19.3 | 1.2 | 40.5 | 24.8% | 670 |
| 22 | 40.9 | 18.1 | 2.5 | 34.5 | 14.0% | 690 |
| 20 | 40.7 | 18.9 | 2.5 | 35.4 | 14.8% | 650 |
| 32 | 39.1 | 20.6 | 2.5 | 34.6 | 14.7% | 520 |
| 99 | 40.8 | 19.1 | 3.5 | 30.1 | 11.1% | 640 |
| 100 | 39.5 | 20.3 | 3.5 | 30.3 | 12.2% | 650 |
| 101 | 39.4 | 20.1 | 3.5 | 30.3 | 12.4% | 510 |
| 102 | 40.7 | 18.5 | 4.0 | 24.4 | 10.4% | 630 |
| 103 | 39.5 | 21.6 | 4.0 | 24.5 | 10.4% | 620 |
| 104 | 39.4 | 19.6 | 4.0 | 24.6 | 10.5% | 590 |

As shown in Table 5, Sample Nos. 95, 98, 32, and 101 are examples in Experiment 6, and in a case where A0 is 75% or more and T1/T2 is more than 1.0, it could be confirmed that the core loss is further lowered by 20% or more in comparison to comparative examples in which T1/T2 is 1.0 or less.

Note that, as shown in Table 5, it could be confirmed that when increasing the packing rate of the metal magnetic particles, the magnetic permeability μ0 tends to increase, and the core loss characteristics and the DC bias characteristics tend to deteriorate. It could be understood that A0 is preferably 90% or less from the viewpoint of maintaining a low core loss, and more preferably 80% or less.

### (Experiment 7)

In Experiment 7, magnetic core samples shown in Table 6 and Table 7 were manufactured by changing specifications of the small particles. Specifically, in Sample No. 105, Fe—Ni-based alloy particles having an average particle size of 1 μm were used as the small particles, in Sample No. 106, Fe—Si-based alloy particles having an average particle size of 1 μm were used as the small particles, in Sample No. 107, Fe—Co-based alloy particles having an average particle size of 1 μm were used as the small particles, and in Sample No. 108, Co particles having an average particle size of 1 μm were used as the small particles. An insulation coating of Ba—Zn—B—Si—Al—O-based oxide glass having an average thickness of 15±10 nm was formed on the small particles of respective samples shown in Table 6. Manufacturing conditions other than the composition of the small particles were set to be similar as in Sample No. 32 in Experiment 2.

In addition, in Sample Nos. 109 and 110 shown in Table 7, two kinds of small particles different in a coating composition were added. Specifically, in Sample No. 109, Fe particles (first small particles) on which a coating of Ba—Zn—B—Si—Al—O-based oxide glass was formed, and Fe particles (second small particles) on which an Si—O-based insulation coating was formed were mixed.

In addition, in Sample No. 110, Fe particles (first small particles) on which a coating of Si—Ba—Mn—O-based oxide glass was formed and Fe particles (second small particles) on which a Si—O-based insulation coating was formed were mixed. In Sample Nos. 109 and 110, an average thickness of the insulation coating of the small particles was within a range of 15±10 nm. Manufacturing conditions other than the above-described conditions were set to be similar as in Sample No. 32 in Experiment 2.

Evaluation results in Experiment 7 are shown in Table 6 and Table 7.

TABLE 6

| | | | Nanocrystalline | | | | | | | |
|---|---|---|---|---|---|---|---|---|---|---|
| | | Amorphous first | second large | | | | | Magnetic | | |
| | | large particles | particles | | Area ratio (%) | | | permeability | DC bias | Core loss |
| | Example/ | Coating | Coating | | First large | Second large | Small | Measured | characteristics | Measured |
| Sample | Comparative | thickness | thickness | Small | particles | particles | particles | value | Measured value | value |
| No. | Example | T1 (nm) | T2 (nm) | particles | AL₁/A0 | AL₂/A0 | AS/A0 | (μ0) | (Variation rate) | (kW/m³) |
| 32 | Example | 100 | 15 | Fe | 40.3 | 39.1 | 20.6 | 34.6 | 14.7% | 520 |
| 105 | Example | 100 | 15 | Fe—Ni | 39.6 | 41.2 | 19.2 | 34.8 | 14.1% | 500 |
| 106 | Example | 100 | 15 | Fe—Si | 40.0 | 39.8 | 20.2 | 34.2 | 14.3% | 510 |
| 107 | Example | 100 | 15 | Fe—Co | 40.2 | 40.1 | 19.7 | 34.1 | 14.5% | 500 |
| 108 | Example | 100 | 15 | Co | 39.8 | 40.2 | 20.0 | 35.1 | 14.7% | 510 |

TABLE 7

| | | Amorphous | Nanocrystalline | | | |
|---|---|---|---|---|---|---|
| | | first large | second large | | | |
| | | particles | particles | | | |
| | Example/ | Coating | Coating | | | Second small |
| Sample | Comparative | thickness | thickness | First small particles | | particles |
| No. | Example | T1 (nm) | T2 (nm) | Composition | Coating composition | Composition |
| 32 | Example | 100 | 15 | Fe | Ba—Zn—B—Si—Al—O-based | — |
| 109 | Example | 100 | 15 | Fe | Ba—Zn—B—Si—Al—O-based | Fe |
| 110 | Example | 100 | 15 | Fe | Si—Ba—Mn ⁻O-based | Fe |

| | | Area ratio (%) | | | | Magnetic | | |
|---|---|---|---|---|---|---|---|---|
| | Second small | First | Second | First | Second | permeability | DC bias | Core loss |
| | particles | large | large | small | small | Measured | characteristics | Measured |
| Sample | Coating | particles | particles | particles | particles | value | Measured value | value |
| No. | composition | AL₁/A0 | AL₂/A0 | AS₁/A0 | AS₂/A0 | (μ0) | (Variation rate) | (kW/m³) |
| 32 | — | 40.3 | 39.1 | 20.6 | — | 34.6 | 14.7% | 520 |
| 109 | Si—O-based | 40.1 | 39.5 | 9.8 | 10.6 | 34.6 | 13.9% | 510 |
| 110 | Si—O-based | 39.3 | 39.8 | 10.1 | 10.8 | 34.8 | 13.1% | 520 |

As shown in Table 6, even in Sample Nos. 105 to 108 in which the composition of the small particles was changed, the core loss could be reduced while maintaining good DC bias characteristics as in Sample No. 32 in Experiment 2. From the results, it could be understood that in a case of adding the small particles to the magnetic core, the composition of the small particles is not particularly limited and can be arbitrarily set.

As shown in Table 7, in Sample Nos. 109 and 110, the DC bias characteristics could be further improved while maintaining a low core loss in comparison to Sample No. 32 in Experiment 2. From the result, it could be understood that when two kinds of small particles different in a coating composition are dispersed in the magnetic core, the DC bias characteristics can be improved while maintaining the low core loss.

### (Experiment 8)

In Experiment 8, three kinds of magnetic core samples (Sample Nos. 111 to 113) shown in Table 8 were manufactured by adding medium particles in combination with the first large particles, the second large particles, and the small particles. Specifically, nanocrystalline Fe—Si—B—Nb—Cu-based alloy particles having an average particle size of 5 μm were added to the magnetic core of Sample No. 111 as the medium particles, crystalline Fe—Si-based alloy particles having an average particle size of 5 μm were added to the magnetic core of Sample No. 112 as the medium particles, and amorphous Fe—Si—B-based alloy particles having an average particle size of 5 μm were added to the magnetic core of Sample No. 113 as the medium particles. Note that, in any of the medium particles used in Experiment 8, D20 was less than 3 μm, and D80 was 3 μm or more. In addition, a coating may not be formed on the medium particles, but the coating is preferably formed from the viewpoint of insulation. In the medium particles used in this experiment, a similar coating powder using P—Zn—Al—O-based oxide glass having an average thickness of 15±10 nm as in the large particles was used.

Manufacturing conditions other than the above-described conditions were set to be similar as in Sample No. 32 in Experiment 2, and the magnetic permeability, the DC bias characteristics, and the core loss were measured. Evaluation results are shown in Table 8.

TABLE 8

| | | | Nanocrystalline | | | |
|---|---|---|---|---|---|---|
| | | Amorphous first | second large | | | |
| | | large particles | particles | | | Area ratio (%) |
| | Example/ | Coating | Coating | Structure of | | First large |
| Sample | Comparative | thickness | thickness | medium | Small | particles |
| No. | Example | T1 (nm) | T2 (nm) | particles | particles | AL₁/A0 |
| 32 | Example | 100 | 15 | — | Fe | 40.3 |
| 111 | Example | 100 | 15 | Nanocrystal | Fe | 39.5 |
| 112 | Example | 100 | 15 | Crystal | Fe | 41.1 |
| 113 | Example | 100 | 15 | Amorphous | Fe | 38.9 |

| | | | | Magnetic | | |
|---|---|---|---|---|---|---|
| | Area ratio (%) | | | permeability | DC bias | Core loss |
| | Second large | Medium | Small | Measured | characteristics | Measured |
| Sample | particles | particles | particles | value | Measured value | value |
| No. | AL₂/A0 | AM/A0 | AS/A0 | (μ0) | (Variation rate) | (kW/m³) |
| 32 | 39.1 | 0.0 | 20.6 | 34.6 | 14.7% | 520 |
| 111 | 39.9 | 10.2 | 10.4 | 34.3 | 13.6% | 540 |
| 112 | 39.3 | 10.2 | 9.4 | 34.6 | 13.5% | 580 |
| 113 | 40.0 | 10.5 | 10.6 | 35.1 | 13.2% | 560 |

As shown in Table 8, even in the respective examples in which the medium particles were added, the core loss could be reduced while maintaining good DC bias characteristics as in Sample No. 32 in Experiment 2. From the evaluation results in Experiment 8, it could be understood that the medium particles may be added to the magnetic core.

### (Experiment 9)

In Experiment 9, magnetic core samples shown in Table 9A and Table 9B were manufactured by changing the composition of the first large particles having the amorphous structure and the composition of the second large particles having the nanocrystal structure. An average particle size of any of the first large particles used in Experiment 9 was 20 μm, and the degree of amorphization of the first large particles was 85% or more. In addition, an average particle size of any of the second large particles used in Experiment 9 was 20 μm, and an average crystallite diameter in the second large particles was within a range of 0.5 to 30 nm.

Note that, Sample Nos. 114 to 136 shown in Table 9A are comparative examples in which only either the first large particles having the amorphous structure or the second large particles having the nanocrystal structure was used. Manufacturing conditions other than a particle composition of Sample Nos. 114 to 136 were set to be similar as in Sample No. 4 or 8 in Experiment 1. Respective examples shown in Table 9B to Table 9G are examples in which the first large particles and the second large particles were mixed. Manufacturing conditions other than the particle composition of respective examples were set to be similar as in Sample No. 32 in Experiment 2.

Evaluation results in Experiment 9 are shown in Table 9A to Table 9G.

TABLE 9A

| | Example/ | Large particles | | |
|---|---|---|---|---|
| | Comparative | | | Coating |
| Sample No. | Example | Structure | Particle composition | composition |
| 4 | Comparative | Amorphous | Fe—Co—B—P—Si—Cr-based | P—Zn—Al—O- |
| | Example | | | based |
| 114 | Comparative | Amorphous | Fe—Si—B-based | P—Zn—Al—O- |
| | Example | | | based |
| 115 | Comparative | Amorphous | Fe—Si—B—C-based | P—Zn—Al—O- |
| | Example | | | based |
| 116 | Comparative | Amorphous | Fe—Si—B—C⁻Cr-based | P—Zn—Al—O- |
| | Example | | | based |
| 117 | Comparative | Amorphous | Fe—P—B-based | P—Zn—Al—O- |
| | Example | | | based |
| 118 | Comparative | Amorphous | Fe—P—B—C-based | P—Zn—Al—O- |
| | Example | | | based |
| 119 | Comparative | Amorphous | Fe—Co—P—C-based | P—Zn—Al—O- |
| | Example | | | based |
| 120 | Comparative | Amorphous | Fe—Co—B-based | P—Zn—Al—O- |
| | Example | | | based |
| 121 | Comparative | Amorphous | Fe—Co—B—Si-based | P—Zn—Al—O- |
| | Example | | | based |
| 122 | Comparative | Amorphous | Fe—Co—Si—B—C-based | P—Zn—Al—O- |
| | Example | | | based |
| 123 | Comparative | Amorphous | Fe—Co—Si—B—C⁻Cr-based | P—Zn—Al—O- |
| | Example | | | based |
| 124 | Comparative | Amorphous | Fe—Co—P—B-based | P—Zn—Al—O- |
| | Example | | | based |
| 125 | Comparative | Amorphous | Fe—Co—P—B—C-based | P—Zn—Al—O- |
| | Example | | | based |
| 8 | Comparative | Nanocrystal | Fe—Si—B—Nb—Cu-based | P—Zn—Al—O- |
| | Example | | | based |
| 126 | Comparative | Nanocrystal | Fe—Si—B—Nb—P-based | P—Zn—Al—O- |
| | Example | | | based |
| 127 | Comparative | Nanocrystal | Fe—P—B—Cu-based | P—Zn—Al—O- |
| | Example | | | based |
| 128 | Comparative | Nanocrystal | Fe—B—Nb—P-based | P—Zn—Al—O- |
| | Example | | | based |
| 129 | Comparative | Nanocrystal | Fe—B—Nb—P—Si-based | P—Zn—Al—O- |
| | Example | | | based |
| 130 | Comparative | Nanocrystal | Fe—B—Nb—P—Si—Cr-based | P—Zn—Al—O- |
| | Example | | | based |
| 131 | Comparative | Nanocrystal | Fe—Co—Si—B—Nb—Cu-based | P—Zn—Al—O- |
| | Example | | | based |
| 132 | Comparative | Nanocrystal | Fe—Co—Si—B—Nb—P-based | P—Zn—Al—O- |
| | Example | | | based |
| 133 | Comparative | Nanocrystal | Fe—Co—P—B—Cu-based | P—Zn—Al—O- |
| | Example | | | based |
| 134 | Comparative | Nanocrystal | Fe—Co—B—Nb—P-based | P—Zn—Al—O- |
| | Example | | | based |
| 135 | Comparative | Nanocrystal | Fe—Co—B—Nb—P—Si-based | P—Zn—Al—O- |
| | Example | | | based |
| 136 | Comparative | Nanocrystal | Fe—Co—B—Nb—P—Si—Cr-based | P—Zn—Al—O- |
| | Example | | | based |

| | Large | | | | Magnetic | | |
|---|---|---|---|---|---|---|---|
| | particles | | | | permeability | DC bias | Core loss |
| | Coating | | | | Measured | characteristics | Measured |
| | thickness | Small | Area ratio (%) | | value | Measured value | value |
| Sample No. | (nm) | particles | AL/A0 | AS/A0 | (μ0) | (Variation rate) | (kW/m³) |
| 4 | 100 | Fe | 80.8 | 19.2 | 35.4 | 8.5% | 940 |
| 114 | 100 | Fe | 78.8 | 21.2 | 34.8 | 8.5% | 880 |
| 115 | 100 | Fe | 80.7 | 19.3 | 35.4 | 8.6% | 890 |
| 116 | 100 | Fe | 81.1 | 18.9 | 35.0 | 8.6% | 900 |
| 117 | 100 | Fe | 80.2 | 19.8 | 35.1 | 8.6% | 920 |
| 118 | 100 | Fe | 80.1 | 19.9 | 35.2 | 8.3% | 910 |
| 119 | 100 | Fe | 80.3 | 19.7 | 35.3 | 8.2% | 900 |
| 120 | 100 | Fe | 79.9 | 20.1 | 35.3 | 7.3% | 1020 |
| 121 | 100 | Fe | 82.0 | 18.0 | 34.6 | 7.0% | 980 |
| 122 | 100 | Fe | 80.5 | 19.5 | 35.1 | 7.0% | 1200 |
| 123 | 100 | Fe | 80.4 | 19.6 | 35.1 | 7.2% | 1100 |
| 124 | 100 | Fe | 80.1 | 19.9 | 35.2 | 7.3% | 1150 |
| 125 | 100 | Fe | 80.4 | 19.6 | 34.8 | 7.5% | 1100 |
| 8 | 15 | Fe | 79.8 | 20.2 | 34.5 | 21.2% | 380 |
| 126 | 15 | Fe | 79.5 | 20.5 | 34.4 | 20.1% | 500 |
| 127 | 15 | Fe | 79.6 | 20.4 | 34.6 | 20.1% | 520 |
| 128 | 15 | Fe | 80.1 | 19.9 | 35.5 | 19.8% | 540 |
| 129 | 15 | Fe | 80.2 | 19.8 | 35.2 | 19.4% | 550 |
| 130 | 15 | Fe | 79.3 | 20.7 | 35.4 | 19.5% | 530 |
| 131 | 15 | Fe | 79.6 | 20.4 | 35.4 | 18.3% | 540 |
| 132 | 15 | Fe | 80.2 | 19.8 | 35.2 | 18.3% | 550 |
| 133 | 15 | Fe | 80.3 | 19.7 | 35.1 | 18.5% | 570 |
| 134 | 15 | Fe | 80.5 | 19.5 | 35.1 | 18.6% | 540 |
| 135 | 15 | Fe | 79.8 | 20.2 | 34.6 | 20.8% | 450 |
| 136 | 15 | Fe | 80.0 | 20.0 | 34.9 | 21.1% | 500 |

TABLE 9B

| | | | | Area ratio (%) | |
|---|---|---|---|---|---|
| | Example/ | Amorphous first large | Nanocrystalline second large | First large | Second large |
| | Comparative | particles | particles | particles | particles |
| Sample No. | Example | Particle composition | Particle composition | AL₁/A0 | AL₂/A0 |
| 32 | Example | Fe—Co—B—P—Si—Cr-based | Fe—Si—B—Nb—Cu-based | 40.3 | 39.1 |
| 137 | Example | Fe—Si—B-based | Fe—Si—B—Nb—Cu-based | 40.4 | 41.1 |
| 138 | Example | Fe—Si—B—C-based | Fe—Si—B—Nb—Cu-based | 40.8 | 39.7 |
| 139 | Example | Fe—Si—B—C⁻Cr-based | Fe—Si—B—Nb—Cu-based | 39.3 | 40.4 |
| 140 | Example | Fe—P—B-based | Fe—Si—B—Nb—Cu-based | 40.0 | 40.1 |
| 141 | Example | Fe—P—B—C-based | Fe—Si—B—Nb—Cu-based | 41.2 | 39.4 |
| 142 | Example | Fe—Co—P—C-based | Fe—Si—B—Nb—Cu-based | 41.4 | 40.6 |
| 143 | Example | Fe—Co—B-based | Fe—Si—B—Nb—Cu-based | 40.5 | 41.0 |
| 144 | Example | Fe—Co—B—Si-based | Fe—Si—B—Nb—Cu-based | 39.8 | 39.8 |
| 145 | Example | Fe—Co—Si—B—C-based | Fe—Si—B—Nb—Cu-based | 40.7 | 38.7 |
| 146 | Example | Fe—Co—Si—B—C⁻Cr-based | Fe—Si—B—Nb—Cu-based | 41.4 | 40.7 |
| 147 | Example | Fe—Co—P—B-based | Fe—Si—B—Nb—Cu-based | 39.8 | 39.6 |
| 148 | Example | Fe—Co—P—B—C-based | Fe—Si—B—Nb—Cu-based | 39.4 | 41.1 |
| 149 | Example | Fe—Co—B—P—Si—Cr-based | Fe—Si—B—Nb—P-based | 40.3 | 38.6 |
| 150 | Example | Fe—Si—B-based | Fe—Si—B—Nb—P-based | 40.4 | 38.8 |
| 151 | Example | Fe—Si—B—C-based | Fe—Si—B—Nb—P-based | 40.7 | 39.9 |
| 152 | Example | Fe—Si—B—C⁻Cr-based | Fe—Si—B—Nb—P-based | 40.3 | 40.4 |
| 153 | Example | Fe—P—B-based | Fe—Si—B—Nb—P-based | 39.3 | 41.3 |
| 154 | Example | Fe—P—B—C-based | Fe—Si—B—Nb—P-based | 40.2 | 39.4 |
| 155 | Example | Fe—Co—P—C-based | Fe—Si—B—Nb—P-based | 38.7 | 39.8 |
| 156 | Example | Fe—Co—B-based | Fe—Si—B—Nb—P-based | 41.2 | 39.5 |
| 157 | Example | Fe—Co—B—Si-based | Fe—Si—B—Nb—P-based | 39.6 | 40.7 |
| 158 | Example | Fe—Co—Si—B—C-based | Fe—Si—B—Nb—P-based | 40.6 | 40.0 |
| 159 | Example | Fe—Co—Si—B—C⁻Cr-based | Fe—Si—B—Nb—P-based | 39.0 | 41.5 |
| 160 | Example | Fe—Co—P—B-based | Fe—Si—B—Nb—P-based | 40.5 | 39.1 |
| 161 | Example | Fe—Co—P—B—C-based | Fe—Si—B—Nb—P-based | 39.6 | 39.9 |

| | | | DC bias | | | |
|---|---|---|---|---|---|---|
| | | Magnetic | characteristics | | | |
| | Area ratio (%) | permeability | Measured | | Core loss | |
| | Small | Measured | value | | Measured | |
| | particles | value | (Variation | Improvement | value | Improvement |
| Sample No. | AS/A0 | (μ0) | rate) | rate | (kW/m³) | rate |
| 32 | 20.6 | 34.6 | 14.7% | −0.1% | 520 | 20.6% |
| 137 | 18.5 | 35.1 | 14.9% | 0.4% | 530 | 18.1% |
| 138 | 19.5 | 35.3 | 14.8% | 0.1% | 530 | 17.1% |
| 139 | 20.3 | 34.7 | 14.6% | 0.3% | 520 | 17.3% |
| 140 | 19.9 | 35.0 | 14.4% | 0.5% | 530 | 18.4% |
| 141 | 19.4 | 34.7 | 14.5% | 0.2% | 530 | 19.2% |
| 142 | 18.0 | 34.6 | 14.8% | 0.2% | 530 | 19.4% |
| 143 | 18.5 | 34.7 | 14.5% | 0.1% | 550 | 22.8% |
| 144 | 20.4 | 34.5 | 14.2% | −0.2% | 530 | 20.3% |
| 145 | 20.6 | 35.3 | 14.0% | −0.2% | 600 | 24.1% |
| 146 | 17.9 | 35.5 | 14.3% | 0.2% | 610 | 19.8% |
| 147 | 20.6 | 35.0 | 14.0% | 0.1% | 600 | 21.1% |
| 148 | 19.5 | 35.1 | 14.5% | 0.1% | 600 | 18.3% |
| 149 | 21.1 | 34.6 | 14.0% | 0.0% | 580 | 18.5% |
| 150 | 20.8 | 35.3 | 14.3% | −0.1% | 540 | 22.3% |
| 151 | 19.4 | 34.8 | 14.0% | 0.4% | 560 | 20.0% |
| 152 | 19.3 | 34.8 | 14.1% | 0.4% | 570 | 18.7% |
| 153 | 19.4 | 35.0 | 15.1% | −0.4% | 550 | 22.6% |
| 154 | 20.4 | 35.1 | 13.8% | 0.3% | 560 | 20.5% |
| 155 | 21.5 | 35.2 | 14.1% | −0.1% | 560 | 18.1% |
| 156 | 19.3 | 35.5 | 13.6% | 0.2% | 630 | 18.6% |
| 157 | 19.7 | 35.2 | 13.7% | 0.0% | 570 | 21.8% |
| 158 | 19.4 | 34.6 | 14.0% | −0.4% | 680 | 20.6% |
| 159 | 19.5 | 35.2 | 14.3% | −0.3% | 650 | 18.2% |
| 160 | 20.4 | 34.7 | 13.6% | 0.0% | 640 | 22.6% |
| 161 | 20.5 | 35.2 | 13.6% | 0.2% | 650 | 18.0% |

TABLE 9C

| | | | | Area ratio (%) | |
|---|---|---|---|---|---|
| | Example/ | Amorphous first large | Nanocrystalline second large | First large | Second large |
| | Comparative | particles | particles | particles | particles |
| Sample No. | Example | Particle composition | Particle composition | AL₁/A0 | AL₂/A0 |
| 162 | Example | Fe—Co—B—P—Si—Cr-based | Fe—P—B—Cu-based | 41.2 | 41.3 |
| 163 | Example | Fe—Si—B-based | Fe—P—B—Cu-based | 40.5 | 39.4 |
| 164 | Example | Fe—Si—B—C-based | Fe—P—B—Cu-based | 38.7 | 41.4 |
| 165 | Example | Fe—Si—B—C⁻Cr-based | Fe—P—B—Cu-based | 40.6 | 39.7 |
| 166 | Example | Fe—P—B-based | Fe—P—B—Cu-based | 40.3 | 39.7 |
| 167 | Example | Fe—P—B—C-based | Fe—P—B—Cu-based | 41.0 | 39.8 |
| 168 | Example | Fe—Co—P—C-based | Fe—P—B—Cu-based | 39.3 | 40.0 |
| 169 | Example | Fe—Co—B-based | Fe—P—B—Cu-based | 40.9 | 40.0 |
| 170 | Example | Fe—Co—B—Si-based | Fe—P—B—Cu-based | 39.7 | 39.4 |
| 171 | Example | Fe—Co—Si—B—C-based | Fe—P—B—Cu-based | 38.6 | 39.5 |
| 172 | Example | Fe—Co—Si—B—C⁻Cr-based | Fe—P—B—Cu-based | 39.0 | 40.0 |
| 173 | Example | Fe—Co—P—B-based | Fe—P—B—Cu-based | 38.6 | 39.6 |
| 174 | Example | Fe—Co—P—B—C-based | Fe—P—B—Cu-based | 39.2 | 40.6 |
| 175 | Example | Fe—Co—B—P—Si—Cr-based | Fe—B—Nb—P-based | 38.9 | 41.4 |
| 176 | Example | Fe—Si—B-based | Fe—B—Nb—P-based | 41.0 | 41.5 |
| 177 | Example | Fe—Si—B—C-based | Fe—B—Nb—P-based | 40.1 | 40.4 |
| 178 | Example | Fe—Si—B—C⁻Cr-based | Fe—B—Nb—P-based | 41.4 | 39.0 |
| 179 | Example | Fe—P—B-based | Fe—B—Nb—P-based | 41.2 | 40.4 |
| 180 | Example | Fe—P—B—C-based | Fe—B—Nb—P-based | 39.3 | 39.8 |
| 181 | Example | Fe—Co—P—C-based | Fe—B—Nb—P-based | 41.0 | 39.4 |
| 182 | Example | Fe—Co—B-based | Fe—B—Nb—P-based | 41.2 | 39.2 |
| 183 | Example | Fe—Co—B—Si-based | Fe—B—Nb—P-based | 38.8 | 38.6 |
| 184 | Example | Fe—Co—Si—B—C-based | Fe—B—Nb—P-based | 38.9 | 40.3 |
| 185 | Example | Fe—Co—Si—B—C⁻Cr-based | Fe—B—Nb—P-based | 40.0 | 41.1 |
| 186 | Example | Fe—Co—P—B-based | Fe—B—Nb—P-based | 40.9 | 39.5 |
| 187 | Example | Fe—Co—P—B—C-based | Fe—B—Nb—P-based | 39.7 | 40.3 |

| | | | DC bias | | | |
|---|---|---|---|---|---|---|
| | | Magnetic | characteristics | | | |
| | Area ratio (%) | permeability | Measured | | Core loss | |
| | Small | Measured | value | | Measured | |
| | particles | value | (Variation | Improvement | value | Improvement |
| Sample No. | AS/A0 | (μ0) | rate) | rate | (kW/m³) | rate |
| 162 | 17.5 | 34.9 | 13.9% | 0.9% | 600 | 19.9% |
| 163 | 20.1 | 35.2 | 14.4% | −0.1% | 570 | 19.7% |
| 164 | 19.9 | 34.7 | 14.4% | 0.2% | 550 | 21.1% |
| 165 | 19.7 | 35.1 | 14.3% | 0.0% | 570 | 19.7% |
| 166 | 20.0 | 34.9 | 14.5% | −0.2% | 570 | 21.0% |
| 167 | 19.2 | 35.0 | 13.7% | 0.6% | 570 | 21.5% |
| 168 | 20.7 | 35.5 | 13.7% | 0.4% | 550 | 21.6% |
| 169 | 19.1 | 35.2 | 13.8% | 0.0% | 630 | 19.6% |
| 170 | 20.9 | 34.7 | 13.7% | −0.4% | 600 | 18.0% |
| 171 | 21.9 | 34.8 | 13.3% | 0.0% | 690 | 17.2% |
| 172 | 21.0 | 35.0 | 13.9% | −0.3% | 650 | 18.2% |
| 173 | 21.8 | 34.9 | 13.4% | 0.1% | 650 | 20.0% |
| 174 | 20.2 | 34.6 | 13.9% | 0.0% | 620 | 22.6% |
| 175 | 19.7 | 35.2 | 14.5% | −0.2% | 600 | 18.0% |
| 176 | 17.5 | 35.2 | 14.4% | 0.3% | 580 | 21.4% |
| 177 | 19.5 | 35.4 | 13.8% | 0.5% | 580 | 18.8% |
| 178 | 19.6 | 34.8 | 14.1% | −0.1% | 580 | 19.7% |
| 179 | 18.4 | 34.7 | 14.4% | 0.0% | 600 | 19.5% |
| 180 | 20.9 | 35.1 | 13.9% | 0.0% | 560 | 21.7% |
| 181 | 19.6 | 34.8 | 13.9% | 0.0% | 590 | 18.6% |
| 182 | 19.6 | 34.7 | 13.3% | 0.2% | 630 | 20.3% |
| 183 | 22.6 | 35.0 | 12.7% | 0.2% | 580 | 19.9% |
| 184 | 20.8 | 35.1 | 13.0% | 0.3% | 680 | 20.1% |
| 185 | 18.9 | 35.3 | 14.2% | −0.5% | 660 | 19.9% |
| 186 | 19.6 | 35.2 | 13.5% | 0.0% | 690 | 19.2% |
| 187 | 20.0 | 34.8 | 13.7% | 0.0% | 640 | 21.5% |

TABLE 9D

| | | | | Area ratio (%) | |
|---|---|---|---|---|---|
| | Example/ | Amorphous first large | Nanocrystalline second large | First large | Second large |
| | Comparative | particles | particles | particles | particles |
| Sample No. | Example | Particle composition | Particle composition | AL₁/A0 | AL₂/A0 |
| 188 | Example | Fe—Co—B—P—Si—Cr-based | Fe—B—Nb—P—Si-based | 40.8 | 40.0 |
| 189 | Example | Fe—Si—B-based | Fe—B—Nb—P—Si-based | 38.6 | 40.4 |
| 190 | Example | Fe—Si—B—C-based | Fe—B—Nb—P—Si-based | 40.2 | 39.6 |
| 191 | Example | Fe—Si—B—C⁻Cr-based | Fe—B—Nb—P—Si-based | 39.3 | 40.8 |
| 192 | Example | Fe—P—B-based | Fe—B—Nb—P—Si-based | 40.8 | 39.6 |
| 193 | Example | Fe—P—B—C-based | Fe—B—Nb—P—Si-based | 40.9 | 39.6 |
| 194 | Example | Fe—Co—P—C-based | Fe—B—Nb—P—Si-based | 38.8 | 40.2 |
| 195 | Example | Fe—Co—B-based | Fe—B—Nb—P—Si-based | 40.0 | 41.0 |
| 196 | Example | Fe—Co—B—Si-based | Fe—B—Nb—P—Si-based | 39.1 | 39.7 |
| 197 | Example | Fe—Co—Si—B—C-based | Fe—B—Nb—P—Si-based | 40.9 | 38.7 |
| 198 | Example | Fe—Co—Si—B—C⁻Cr-based | Fe—B—Nb—P—Si-based | 40.2 | 38.6 |
| 199 | Example | Fe—Co—P—B-based | Fe—B—Nb—P—Si-based | 40.8 | 39.7 |
| 200 | Example | Fe—Co—P—B—C-based | Fe—B—Nb—P—Si-based | 41.3 | 40.3 |
| 201 | Example | Fe—Co—B—P—Si—Cr-based | Fe—B—Nb—P—Si—Cr-based | 40.7 | 39.0 |
| 202 | Example | Fe—Si—B-based | Fe—B—Nb—P—Si—Cr-based | 40.6 | 39.5 |
| 203 | Example | Fe—Si—B—C-based | Fe—B—Nb—P—Si—Cr-based | 39.4 | 39.1 |
| 204 | Example | Fe—Si—B—C⁻Cr-based | Fe—B—Nb—P—Si—Cr-based | 39.8 | 38.7 |
| 205 | Example | Fe—P—B-based | Fe—B—Nb—P—Si—Cr-based | 38.7 | 39.4 |
| 206 | Example | Fe—P—B—C-based | Fe—B—Nb—P—Si—Cr-based | 39.0 | 40.9 |
| 207 | Example | Fe—Co—P—C-based | Fe—B—Nb—P—Si—Cr-based | 39.2 | 38.7 |
| 208 | Example | Fe—Co—B-based | Fe—B—Nb—P—Si—Cr-based | 38.9 | 38.8 |
| 209 | Example | Fe—Co—B—Si-based | Fe—B—Nb—P—Si—Cr-based | 40.0 | 41.4 |
| 210 | Example | Fe—Co—Si—B—C-based | Fe—B—Nb—P—Si—Cr-based | 40.7 | 40.7 |
| 211 | Example | Fe—Co—Si—B—C⁻Cr-based | Fe—B—Nb—P—Si—Cr-based | 38.9 | 40.7 |
| 212 | Example | Fe—Co—P—B-based | Fe—B—Nb—P—Si—Cr-based | 41.4 | 41.2 |
| 213 | Example | Fe—Co—P—B—C-based | Fe—B—Nb—P—Si—Cr-based | 38.6 | 41.4 |

| | | Magnetic | DC bias characteristics | | | |
|---|---|---|---|---|---|---|
| | Area ratio (%) | permeability | Measured | | Core loss | |
| | Small | Measured | value | | Measured | |
| | particles | value | (Variation | Improvement | value | Improvement |
| Sample No. | AS/A0 | (μ0) | rate) | rate | (kW/m³) | rate |
| 188 | 19.2 | 35.3 | 13.5% | 0.5% | 590 | 21.3% |
| 189 | 21.0 | 34.9 | 14.0% | −0.1% | 580 | 18.1% |
| 190 | 20.2 | 34.8 | 14.3% | −0.4% | 570 | 20.3% |
| 191 | 19.9 | 35.3 | 14.4% | −0.4% | 580 | 19.0% |
| 192 | 19.6 | 35.4 | 14.0% | 0.0% | 600 | 18.9% |
| 193 | 19.5 | 35.0 | 14.1% | −0.3% | 600 | 18.5% |
| 194 | 21.0 | 35.3 | 13.9% | −0.2% | 550 | 22.6% |
| 195 | 19.0 | 35.3 | 13.7% | −0.1% | 620 | 21.7% |
| 196 | 21.2 | 34.7 | 12.6% | 0.3% | 600 | 18.9% |
| 197 | 20.4 | 35.5 | 13.1% | −0.2% | 710 | 18.9% |
| 198 | 21.2 | 35.4 | 12.9% | 0.0% | 660 | 19.0% |
| 199 | 19.5 | 35.4 | 13.7% | −0.4% | 670 | 21.9% |
| 200 | 18.4 | 35.4 | 13.2% | 0.4% | 660 | 21.6% |
| 201 | 20.3 | 34.5 | 14.4% | −0.5% | 570 | 22.4% |
| 202 | 19.9 | 35.4 | 13.8% | 0.3% | 570 | 20.5% |
| 203 | 21.5 | 34.8 | 13.3% | 0.5% | 540 | 22.4% |
| 204 | 21.5 | 35.4 | 14.0% | −0.3% | 580 | 17.2% |
| 205 | 21.9 | 34.6 | 13.8% | 0.0% | 550 | 22.2% |
| 206 | 20.1 | 35.0 | 14.4% | −0.3% | 570 | 20.4% |
| 207 | 22.1 | 35.4 | 13.7% | −0.2% | 550 | 21.2% |
| 208 | 22.3 | 34.7 | 12.7% | 0.4% | 620 | 18.0% |
| 209 | 18.6 | 34.7 | 13.2% | 0.4% | 610 | 19.2% |
| 210 | 18.6 | 34.5 | 13.4% | 0.1% | 720 | 18.1% |
| 211 | 20.4 | 34.8 | 13.9% | −0.4% | 640 | 20.4% |
| 212 | 17.4 | 34.7 | 14.3% | −0.4% | 700 | 19.5% |
| 213 | 20.0 | 35.3 | 13.9% | −0.1% | 640 | 20.5% |

TABLE 9E

| | | | | Area ratio (%) | |
|---|---|---|---|---|---|
| | Example/ | Amorphous first large | Nanocrystalline second large | First large | Second large |
| | Comparative | particles | particles | particles | particles |
| Sample No. | Example | Particle composition | Particle composition | AL₁/A0 | AL₂/A0 |
| 214 | Example | Fe—Co—B—P—Si—Cr-based | Fe—Co—Si—B—Nb—Cu-based | 40.3 | 40.6 |
| 215 | Example | Fe—Si—B-based | Fe—Co—Si—B—Nb—Cu-based | 39.1 | 39.0 |
| 216 | Example | Fe—Si—B—C-based | Fe—Co—Si—B—Nb—Cu-based | 39.5 | 40.2 |
| 217 | Example | Fe—Si—B—C⁻Cr-based | Fe—Co—Si—B—Nb—Cu-based | 39.1 | 39.3 |
| 218 | Example | Fe—P—B-based | Fe—Co—Si—B—Nb—Cu-based | 39.5 | 39.3 |
| 219 | Example | Fe—P—B—C-based | Fe—Co—Si—B—Nb—Cu-based | 41.5 | 41.3 |
| 220 | Example | Fe—Co—P—C-based | Fe—Co—Si—B—Nb—Cu-based | 39.3 | 39.6 |
| 221 | Example | Fe—Co—B-based | Fe—Co—Si—B—Nb—Cu-based | 39.3 | 40.9 |
| 222 | Example | Fe—Co—B—Si-based | Fe—Co—Si—B—Nb—Cu-based | 39.2 | 41.1 |
| 223 | Example | Fe—Co—Si—B—C-based | Fe—Co—Si—B—Nb—Cu-based | 40.8 | 41.2 |
| 224 | Example | Fe—Co—Si—B—C⁻Cr-based | Fe—Co—Si—B—Nb—Cu-based | 40.0 | 41.2 |
| 225 | Example | Fe—Co—P—B-based | Fe—Co—Si—B—Nb—Cu-based | 40.6 | 40.7 |
| 226 | Example | Fe—Co—P—B—C-based | Fe—Co—Si—B—Nb—Cu-based | 40.0 | 38.5 |
| 227 | Example | Fe—Co—B—P—Si—Cr-based | Fe—Co—Si—B—Nb—P-based | 39.7 | 40.4 |
| 228 | Example | Fe—Si—B-based | Fe—Co—Si—B—Nb—P-based | 39.8 | 41.2 |
| 229 | Example | Fe—Si—B—C-based | Fe—Co—Si—B—Nb—P-based | 38.6 | 41.2 |
| 230 | Example | Fe—Si—B—C⁻Cr-based | Fe—Co—Si—B—Nb—P-based | 40.5 | 40.0 |
| 231 | Example | Fe—P—B-based | Fe—Co—Si—B—Nb—P-based | 41.1 | 39.9 |
| 232 | Example | Fe—P—B—C-based | Fe—Co—Si—B—Nb—P-based | 40.4 | 39.4 |
| 233 | Example | Fe—Co—P—C-based | Fe—Co—Si—B—Nb—P-based | 40.7 | 41.1 |
| 234 | Example | Fe—Co—B-based | Fe—Co—Si—B—Nb—P-based | 40.5 | 40.9 |
| 235 | Example | Fe—Co—B—Si-based | Fe—Co—Si—B—Nb—P-based | 40.5 | 39.7 |
| 236 | Example | Fe—Co—Si—B—C-based | Fe—Co—Si—B—Nb—P-based | 39.0 | 38.9 |
| 237 | Example | Fe—Co—Si—B—C⁻Cr-based | Fe—Co—Si—B—Nb—P-based | 39.0 | 40.6 |
| 238 | Example | Fe—Co—P—B-based | Fe—Co—Si—B—Nb—P-based | 39.2 | 39.5 |
| 239 | Example | Fe—Co—P—B—C-based | Fe—Co—Si—B—Nb—P-based | 41.5 | 40.7 |

| | | Magnetic | DC bias characteristics | | | |
|---|---|---|---|---|---|---|
| | Area ratio (%) | permeability | Measured | | Core loss | |
| | Small | Measured | value | | Measured | |
| | particles | value | (Variation | Improvement | value | Improvement |
| Sample No. | AS/A0 | (μ0) | rate) | rate | (kW/m³) | rate |
| 214 | 19.1 | 35.0 | 13.9% | −0.3% | 600 | 19.4% |
| 215 | 21.9 | 34.9 | 13.0% | 0.2% | 560 | 20.1% |
| 216 | 20.3 | 35.4 | 13.4% | 0.1% | 560 | 20.9% |
| 217 | 21.6 | 35.1 | 13.4% | −0.2% | 570 | 18.6% |
| 218 | 21.2 | 34.9 | 13.4% | −0.1% | 560 | 22.2% |
| 219 | 17.2 | 35.2 | 13.4% | 0.4% | 600 | 20.2% |
| 220 | 21.1 | 35.1 | 12.8% | 0.3% | 570 | 19.6% |
| 221 | 19.8 | 35.2 | 13.2% | −0.2% | 640 | 17.9% |
| 222 | 19.7 | 34.7 | 13.3% | −0.5% | 580 | 22.4% |
| 223 | 18.0 | 34.7 | 13.1% | −0.1% | 700 | 21.1% |
| 224 | 18.8 | 34.9 | 13.4% | −0.3% | 670 | 19.0% |
| 225 | 18.7 | 34.9 | 12.9% | 0.2% | 690 | 19.7% |
| 226 | 21.5 | 34.6 | 12.6% | 0.0% | 640 | 20.8% |
| 227 | 19.9 | 34.5 | 13.8% | −0.4% | 580 | 21.5% |
| 228 | 19.0 | 34.9 | 13.9% | −0.2% | 590 | 18.8% |
| 229 | 20.2 | 34.7 | 13.8% | −0.3% | 570 | 19.5% |
| 230 | 19.5 | 34.7 | 13.6% | −0.2% | 580 | 19.9% |
| 231 | 19.0 | 35.2 | 13.3% | 0.2% | 580 | 22.2% |
| 232 | 20.2 | 35.4 | 13.5% | −0.3% | 590 | 19.1% |
| 233 | 18.2 | 34.5 | 13.3% | 0.2% | 580 | 21.4% |
| 234 | 18.6 | 34.6 | 13.0% | 0.0% | 640 | 19.7% |
| 235 | 19.8 | 34.9 | 12.1% | 0.4% | 610 | 19.3% |
| 236 | 22.1 | 35.4 | 12.3% | 0.0% | 660 | 22.2% |
| 237 | 20.4 | 35.0 | 12.2% | 0.6% | 630 | 22.4% |
| 238 | 21.3 | 34.7 | 13.5% | −0.9% | 680 | 18.4% |
| 239 | 17.8 | 34.8 | 12.5% | 0.7% | 680 | 19.7% |

TABLE 9F

| | | | | Area ratio (%) | |
|---|---|---|---|---|---|
| | Example/ | Amorphous first large | Nanocrystalline second large | First large | Second large |
| | Comparative | particles | particles | particles | particles |
| Sample No. | Example | Particle composition | Particle composition | AL₁/A0 | AL₂/A0 |
| 240 | Example | Fe—Co—B—P—Si—Cr-based | Fe—Co—P—B—Cu-based | 41.1 | 39.5 |
| 241 | Example | Fe—Si—B-based | Fe—Co—P—B—Cu-based | 39.6 | 39.9 |
| 242 | Example | Fe—Si—B—C-based | Fe—Co—P—B—Cu-based | 40.0 | 40.9 |
| 243 | Example | Fe—Si—B—C⁻Cr-based | Fe—Co—P—B—Cu-based | 39.4 | 40.9 |
| 244 | Example | Fe—P—B-based | Fe—Co—P—B—Cu-based | 40.3 | 39.8 |
| 245 | Example | Fe—P—B—C-based | Fe—Co—P—B—Cu-based | 40.7 | 39.3 |
| 246 | Example | Fe—Co—P—C-based | Fe—Co—P—B—Cu-based | 39.9 | 41.0 |
| 247 | Example | Fe—Co—B-based | Fe—Co—P—B—Cu-based | 40.7 | 39.8 |
| 248 | Example | Fe—Co—B—Si-based | Fe—Co—P—B—Cu-based | 39.5 | 40.7 |
| 249 | Example | Fe—Co—Si—B—C-based | Fe—Co—P—B—Cu-based | 39.9 | 39.7 |
| 250 | Example | Fe—Co—Si—B—C⁻Cr-based | Fe—Co—P—B—Cu-based | 40.0 | 40.4 |
| 251 | Example | Fe—Co—P—B-based | Fe—Co—P—B—Cu-based | 40.7 | 40.6 |
| 252 | Example | Fe—Co—P—B—C-based | Fe—Co—P—B—Cu-based | 41.3 | 39.6 |
| 253 | Example | Fe—Co—B—P—Si—Cr-based | Fe—Co—B—Nb—P-based | 38.6 | 39.7 |
| 254 | Example | Fe—Si—B-based | Fe—Co—B—Nb—P-based | 39.2 | 39.3 |
| 255 | Example | Fe—Si—B—C-based | Fe—Co—B—Nb—P-based | 39.2 | 41.4 |
| 256 | Example | Fe—Si—B—C⁻Cr-based | Fe—Co—B—Nb—P-based | 40.9 | 40.1 |
| 257 | Example | Fe—P—B-based | Fe—Co—B—Nb—P-based | 39.7 | 39.3 |
| 258 | Example | Fe—P—B—C-based | Fe—Co—B—Nb—P-based | 39.0 | 39.6 |
| 259 | Example | Fe—Co—P—C-based | Fe—Co—B—Nb—P-based | 40.2 | 39.4 |
| 260 | Example | Fe—Co—B-based | Fe—Co—B—Nb—P-based | 41.3 | 39.9 |
| 261 | Example | Fe—Co—B—Si-based | Fe—Co—B—Nb—P-based | 39.6 | 40.5 |
| 262 | Example | Fe—Co—Si—B—C-based | Fe—Co—B—Nb—P-based | 40.1 | 40.1 |
| 263 | Example | Fe—Co—Si—B—C⁻Cr-based | Fe—Co—B—Nb—P-based | 40.7 | 41.3 |
| 264 | Example | Fe—Co—P—B-based | Fe—Co—B—Nb—P-based | 39.9 | 38.7 |
| 265 | Example | Fe—Co—P—B—C-based | Fe—Co—B—Nb—P-based | 39.1 | 40.0 |

| | Area ratio (%) | Magnetic | DC bias characteristics | | Core loss | |
|---|---|---|---|---|---|---|
| | Small | permeability | Measured | | Measured | |
| | particles | Measured | value | Improvement | value | Improvement |
| Sample No. | AS/A0 | value (μ0) | (Variation rate) | rate | (kW/m³) | rate |
| 240 | 19.4 | 35.4 | 13.3% | 0.1% | 600 | 20.9% |
| 241 | 20.5 | 34.6 | 13.5% | 0.0% | 580 | 20.1% |
| 242 | 19.1 | 34.5 | 14.2% | −0.5% | 580 | 20.7% |
| 243 | 19.7 | 35.1 | 13.9% | −0.3% | 570 | 21.7% |
| 244 | 19.9 | 35.4 | 13.2% | 0.3% | 610 | 18.1% |
| 245 | 20.0 | 34.6 | 12.9% | 0.4% | 590 | 20.4% |
| 246 | 19.1 | 35.3 | 13.8% | −0.3% | 580 | 21.4% |
| 247 | 19.5 | 35.3 | 12.8% | 0.1% | 650 | 19.0% |
| 248 | 19.8 | 35.5 | 12.3% | 0.4% | 600 | 21.2% |
| 249 | 20.4 | 34.8 | 13.0% | −0.4% | 710 | 19.0% |
| 250 | 19.6 | 35.3 | 13.4% | −0.5% | 660 | 20.9% |
| 251 | 18.7 | 35.4 | 13.0% | 0.1% | 700 | 19.8% |
| 252 | 19.1 | 34.8 | 12.7% | 0.3% | 670 | 20.8% |
| 253 | 21.7 | 35.2 | 13.1% | 0.1% | 580 | 19.0% |
| 254 | 21.5 | 34.7 | 13.3% | 0.0% | 570 | 18.7% |
| 255 | 19.4 | 35.3 | 13.5% | 0.2% | 570 | 19.7% |
| 256 | 19.0 | 34.5 | 13.4% | 0.2% | 560 | 22.5% |
| 257 | 21.0 | 34.7 | 13.4% | −0.1% | 590 | 17.9% |
| 258 | 21.4 | 35.1 | 13.3% | −0.1% | 550 | 22.4% |
| 259 | 20.4 | 35.0 | 13.5% | −0.3% | 560 | 21.7% |
| 260 | 18.8 | 34.6 | 13.0% | 0.0% | 640 | 19.5% |
| 261 | 19.9 | 35.2 | 12.6% | 0.1% | 590 | 20.8% |
| 262 | 19.8 | 34.8 | 12.3% | 0.5% | 710 | 18.1% |
| 263 | 18.0 | 34.5 | 13.2% | 0.0% | 650 | 22.1% |
| 264 | 21.4 | 34.8 | 12.9% | −0.3% | 650 | 21.9% |
| 265 | 20.9 | 34.8 | 12.5% | 0.4% | 630 | 21.6% |

TABLE 9G

| | | | | Area ratio (%) | |
|---|---|---|---|---|---|
| | Example/ | Amorphous first large | Nanocrystalline second large | First large | Second large |
| | Comparative | particles | particles | particles | particles |
| Sample No. | Example | Particle composition | Particle composition | AL₁/A0 | AL₂/A0 |
| 266 | Example | Fe—Co—B—P—Si—Cr-based | Fe—Co—B—Nb—P—Si-based | 39.5 | 39.9 |
| 267 | Example | Fe—Si—B-based | Fe—Co—B—Nb—P—Si-based | 38.7 | 40.4 |
| 268 | Example | Fe—Si—B—C-based | Fe—Co—B—Nb—P—Si-based | 40.9 | 41.2 |
| 269 | Example | Fe—Si—B—C⁻Cr-based | Fe—Co—B—Nb—P—Si-based | 38.8 | 39.6 |
| 270 | Example | Fe—P—B-based | Fe—Co—B—Nb—P—Si-based | 39.4 | 40.2 |
| 271 | Example | Fe—P—B—C-based | Fe—Co—B—Nb—P—Si-based | 40.2 | 40.9 |
| 272 | Example | Fe—Co—P—C-based | Fe—Co—B—Nb—P—Si-based | 41.2 | 40.3 |
| 273 | Example | Fe—Co—B-based | Fe—Co—B—Nb—P—Si-based | 41.3 | 40.8 |
| 274 | Example | Fe—Co—B—Si-based | Fe—Co—B—Nb—P—Si-based | 40.8 | 39.6 |
| 275 | Example | Fe—Co—Si—B—C-based | Fe—Co—B—Nb—P—Si-based | 40.6 | 39.5 |
| 276 | Example | Fe—Co—Si—B—C⁻Cr-based | Fe—Co—B—Nb—P—Si-based | 39.9 | 41.4 |
| 277 | Example | Fe—Co—P—B-based | Fe—Co—B—Nb—P—Si-based | 39.7 | 40.2 |
| 278 | Example | Fe—Co—P—B—C-based | Fe—Co—B—Nb—P—Si-based | 39.0 | 41.0 |
| 279 | Example | Fe—Co—B—P—Si—Cr-based | Fe—Co—B—Nb—P—Si—Cr-based | 41.2 | 40.1 |
| 280 | Example | Fe—Si—B-based | Fe—Co—B—Nb—P—Si—Cr-based | 39.6 | 40.7 |
| 281 | Example | Fe—Si—B—C-based | Fe—Co—B—Nb—P—Si—Cr-based | 40.8 | 39.8 |
| 282 | Example | Fe—Si—B—C⁻Cr-based | Fe—Co—B—Nb—P—Si—Cr-based | 41.1 | 41.2 |
| 283 | Example | Fe—P—B-based | Fe—Co—B—Nb—P—Si—Cr-based | 41.3 | 39.2 |
| 284 | Example | Fe—P—B—C-based | Fe—Co—B—Nb—P—Si—Cr-based | 41.3 | 41.0 |
| 285 | Example | Fe—Co—P—C-based | Fe—Co—B—Nb—P—Si—Cr-based | 41.5 | 41.4 |
| 286 | Example | Fe—Co—B-based | Fe—Co—B—Nb—P—Si—Cr-based | 38.9 | 40.8 |
| 287 | Example | Fe—Co—B—Si-based | Fe—Co—B—Nb—P—Si—Cr-based | 38.8 | 39.7 |
| 288 | Example | Fe—Co—Si—B—C-based | Fe—Co—B—Nb—P—Si—Cr-based | 40.5 | 39.1 |
| 289 | Example | Fe—Co—Si—B—C⁻Cr-based | Fe—Co—B—Nb—P—Si—Cr-based | 40.5 | 40.4 |
| 290 | Example | Fe—Co—P—B-based | Fe—Co—B—Nb—P—Si—Cr-based | 39.9 | 41.2 |
| 291 | Example | Fe—Co—P—B—C-based | Fe—Co—B—Nb—P—Si—Cr-based | 40.9 | 39.8 |

| | Area ratio (%) | Magnetic | DC bias characteristics | | Core loss | |
|---|---|---|---|---|---|---|
| | Small | permeability | Measured | | Measured | |
| | particles | Measured | value | Improvement | value | Improvement |
| Sample No. | AS/A0 | value (μ0) | (Variation rate) | rate | (kW/m³) | rate |
| 266 | 20.6 | 35.3 | 14.5% | 0.1% | 540 | 21.1% |
| 267 | 20.9 | 35.1 | 14.4% | 0.3% | 530 | 19.7% |
| 268 | 17.9 | 35.3 | 14.9% | 0.2% | 560 | 18.1% |
| 269 | 21.6 | 34.5 | 14.3% | 0.1% | 530 | 18.9% |
| 270 | 20.4 | 34.7 | 14.5% | 0.2% | 540 | 20.4% |
| 271 | 18.9 | 35.3 | 14.9% | −0.1% | 530 | 22.9% |
| 272 | 18.5 | 35.5 | 14.3% | 0.4% | 540 | 21.6% |
| 273 | 17.9 | 34.6 | 14.5% | −0.1% | 600 | 20.8% |
| 274 | 19.6 | 34.8 | 13.4% | 0.4% | 560 | 21.2% |
| 275 | 19.9 | 34.9 | 14.0% | −0.2% | 660 | 20.3% |
| 276 | 18.7 | 34.9 | 14.2% | 0.2% | 620 | 20.4% |
| 277 | 20.1 | 35.1 | 14.1% | 0.0% | 650 | 18.4% |
| 278 | 20.0 | 34.7 | 14.1% | 0.2% | 600 | 21.5% |
| 279 | 18.7 | 34.7 | 15.3% | −0.4% | 590 | 19.2% |
| 280 | 19.7 | 34.5 | 14.7% | 0.3% | 570 | 18.2% |
| 281 | 19.4 | 35.3 | 14.6% | 0.2% | 580 | 17.0% |
| 282 | 17.7 | 34.8 | 15.2% | 0.0% | 580 | 18.7% |
| 283 | 19.5 | 34.8 | 14.3% | 0.5% | 590 | 17.9% |
| 284 | 17.7 | 35.0 | 14.6% | 0.5% | 570 | 21.4% |
| 285 | 17.1 | 35.4 | 14.9% | 0.3% | 590 | 18.5% |
| 286 | 20.3 | 34.6 | 14.8% | −0.5% | 590 | 21.5% |
| 287 | 21.5 | 35.0 | 13.3% | 0.5% | 570 | 19.9% |
| 288 | 20.4 | 35.3 | 14.2% | −0.4% | 700 | 17.5% |
| 289 | 19.1 | 35.1 | 14.5% | −0.2% | 640 | 20.7% |
| 290 | 18.9 | 35.3 | 14.0% | 0.5% | 650 | 21.7% |
| 291 | 19.3 | 35.3 | 14.1% | 0.2% | 650 | 19.6% |

In any of respective examples shown in Table 9B to Table 9G, an improvement rate of the core loss became 15% or more while maintaining good DC bias characteristics. From the results in Experiment 9, it could be understood that the particle composition of the first large particles and the second large particles can be arbitrarily selected without a particular limitation.

### EXPLANATIONS OF LETTERS OR NUMERALS

2 MAGNETIC CORE
10 METAL MAGNETIC PARTICLE
10a FIRST PARTICLE GROUP
11 LARGE PARTICLE
11a FIRST LARGE PARTICLE
11b SECOND LARGE PARTICLE
4 INSULATION COATING OF LARGE PARTICLE
4a INSULATION COATING OF FIRST LARGE PARTICLE
4b INSULATION COATING OF SECOND LARGE PARTICLE
10b SECOND PARTICLE GROUP
12 SMALL PARTICLE
12a FIRST SMALL PARTICLE
12b SECOND SMALL PARTICLE
6 INSULATION COATING OF SMALL PARTICLE
6a FIRST INSULATION COATING
6b SECOND INSULATION COATING
13 MEDIUM PARTICLE
20 RESIN
60 POWDER TREATMENT DEVICE
61 CHAMBER
62 BLADE
63 MIXTURE
100 MAGNETIC COMPONENT
5 COIL
5a END PORTION
5b END PORTION
7, 9 EXTERNAL ELECTRODE

What is claimed is:

1. A magnetic core containing metal magnetic particles,
wherein a total area ratio occupied by the metal magnetic particles on a cross-section of the magnetic core is 75% or more,
the metal magnetic particles include,
first large particles comprising an amorphous structure and having a Heywood diameter of 3 μm or more on the cross-section of the magnetic core, and
second large particles comprising a nanocrystal structure and having a Heywood diameter of 3 μm or more on the cross-section of the magnetic core, and
an insulation coating of the first large particles is thicker than an insulation coating of the second large particles.

2. The magnetic core according to claim 1,
wherein T1/T2 is 1.3 to 40, in which an average thickness of the insulation coating of the first large particles is set to T1, and
an average thickness of the insulation coating of the second large particles is set to T2.

3. The magnetic core according to claim 1,
wherein the average thickness T2 of the insulation coating of the second large particles is 5 to 50 nm.

4. The magnetic core according to claim 1,
wherein the metal magnetic particles include a particle group in which a Heywood diameter on the cross-section of the magnetic core is less than 3 μm.

5. The magnetic core according to claim 4,
wherein the particle group in which the Heywood diameter is less than 3 μm includes two or more kinds of small particles different in a coating composition.

6. A magnetic component comprising the magnetic core according to claim 1.

7. A magnetic component comprising a magnetic body containing metal magnetic particles,
wherein a total area ratio occupied by the metal magnetic particles on a cross-section of the magnetic body is 75% or more,
the metal magnetic particles include,
first large particles comprising an amorphous structure and having a Heywood diameter of 3 μm or more on the cross-section of the magnetic body, and
second large particles comprising a nanocrystal structure and having a Heywood diameter of 3 μm or more on the cross-section of the magnetic body, and
an insulation coating of the first large particles is thicker than an insulation coating of the second large particles.
